(19) United States
(12) Patent Application Publication
(10) Pub. No.: US 2021/0373951 A1
(43) Pub. Date: Dec. 2, 2021

(54) SYSTEMS AND METHODS FOR COMPOSABLE COHERENT DEVICES

(71) Applicant: Samsung Electronics Co., Ltd., Suwon-si (KR)

(72) Inventors: Krishna T. Malladi, San Jose, CA (US); Andrew Chang, Los Altos, CA (US); Ehsan Najafabadi, San Jose, CA (US); Yasser A. Zaghloul, San Jose, CA (US)

(21) Appl. No.: 17/135,901

(22) Filed: Dec. 28, 2020

Related U.S. Application Data
(60) Provisional application No. 63/031,508, filed on May 28, 2020.
(60) Provisional application No. 63/031,509, filed on May 28, 2020.
(60) Provisional application No. 63/068,054, filed on Aug. 20, 2020.
(60) Provisional application No. 63/057,746, filed on Jul. 28, 2020.

(51) Int. Cl. G06F 9/50; G06F 13/40; G06F 13/42; G06F 13/16

(52) U.S. Cl. CPC G06F 9/505; G06F 9/5016; G06F 13/4027; G06F 2213/0026; G06F 13/1668; G06F 2209/5022; G06F 2209/505; G06F 13/4282

(57) ABSTRACT

Provided are systems, methods, and apparatuses for resource allocation. The method can include: determining a first value of a parameter associated with at least one first device in a first cluster; determining a threshold based on the first value of the parameter; receiving a request for processing a workload at the first device; determining that a second value of the parameter associated with at least one second device in a second cluster meets the threshold; and responsive to meeting the threshold, routing at least a portion of the workload to the second device.

### CROSS-REFERENCE TO RELATED APPLICATION(S)

The present application claims priority to and the benefit of U.S. Provisional Application No. 63/031,508, filed May 28, 2020, entitled “EXTENDING MEMORY ACCESSES WITH NOVEL CACHE COHERENCE CONNECTS”, and priority to and the benefit of U.S. Provisional Application No. 63/031,509, filed May 28, 2020, entitled “POOLING SERVER MEMORY RESOURCES FOR COMPUTE EFFICIENCY”, and priority to and the benefit of U.S. Provisional Application No. 63/068,054, filed Aug. 20, 2020, entitled “SYSTEM WITH CACHE-COHERENT MEMORY AND SERVER-LINKING SWITCH FIELD”, and priority to and the benefit of U.S. Provisional Application No. 63/057,746, filed Jul. 28, 2020, entitled “DISAGGREGATED MEMORY ARCHITECTURE WITH NOVEL INTERCONNECTS”, the entire contents of all which is incorporated herein by reference.

### FIELD

The present disclosure generally relates to cache coherency, and more specifically, to systems and methods for composable coherent devices.

### BACKGROUND

Some server systems may include collections of servers connected by a network protocol. Each of the servers in such a system may include processing resources (e.g., processors) and memory resources (e.g., system memory). It may be advantageous, in some circumstances, for a processing resource of one server to access a memory resource of another server, and it may be advantageous for this access to occur while minimizing the processing resources of either server.

Thus, there is a need for an improved system and method for managing memory resources in a system including one or more servers.

The above information disclosed in this Background section is only for enhancement of understanding of the background of the disclosure and therefore it may contain information that does not constitute prior art.

### SUMMARY

In various embodiments, described herein include systems, methods, and apparatuses for resource allocation. In some embodiments, a method for resource allocation is described. The method can include: determining a first value of a parameter associated with at least one first device in a first cluster; determining a threshold based on the first value of the parameter; receiving a request for processing a workload at the first device; determining that a second value of the parameter associated with at least one second device in a second cluster meets the threshold; and responsive to meeting the threshold, routing at least a portion of the workload to the second device.

In various embodiments, the method can further include: determining that the second value of the parameter associated with at least one second device in a second cluster exceeds the threshold; and responsive to exceeding the threshold, maintaining at least a portion of the workload at the first device. In another embodiment, the first cluster or second cluster includes at least one of a direct-attached memory architecture, a pooled memory architecture, a distributed memory architecture, or a disaggregated memory architecture. In some embodiments, the direct-attach memory architecture includes at least one of a storage class memory (SCM) device, a dynamic random-access memory (DRAM) device, and a DRAM-based vertical NAND device. In another embodiment, the pooled memory architecture includes a cache coherent accelerator device. In another embodiment, the distributed memory architecture includes cache coherent devices connected with PCIe interconnects. In some embodiment, the disaggregated memory architecture includes a physically clustered memory and accelerator extension in a chassis.

In various embodiments, the method can further include: calculating a score based on a projected memory usage of the workload, the first value, and the second value; and routing at least a portion of the workload to the second device based on the score. In another embodiment, the cache coherent protocol includes at least one of a CXL protocol or GenZ protocol, and the first cluster and the second cluster are coupled via a PCIe fabric. In one embodiment, the resource includes at least one of a memory resource or a computing resource. In another embodiment, the performance parameter includes at least one of a power characteristic, a performance per unit of energy characteristic, a remote memory capacity, and a direct memory capacity. In some embodiments, the method can include presenting at least the second device to a host.

Similarly, devices and systems for performing substantially the same or similar operations as described above are further disclosed.

Accordingly, particular embodiments of the subject matter described herein can be implemented so as to realize one or more of the following advantages. Reduce network latencies and improve network stability and operational data transfer rates and, in turn, improve the user experience. Reduce costs associated with routing network traffic, network maintenance, network upgrades, and/or the like. Further, in some aspects, the disclosed systems can serve to reduce the power consumption and/or bandwidth of devices on a network, and may serve to increase the speed and/or efficiency of communications between devices.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A is a block diagram of a system for attaching memory resources to computing resources using a cache-coherent connection, according to an embodiment of the present disclosure;

FIG. 1B is a block diagram of a system, employing expansion socket adapters, for attaching memory resources to computing resources using a cache-coherent connection, according to an embodiment of the present disclosure;

FIG. 1C is a block diagram of a system for aggregating memory employing an Ethernet top of rack (ToR) switch, according to an embodiment of the present disclosure;

FIG. 1D is a block diagram of a system for aggregating memory employing an Ethernet ToR switch and an expansion socket adapter, according to an embodiment of the present disclosure;

FIG. 1E is a block diagram of a system for aggregating memory, according to an embodiment of the present disclosure;

FIG. 1F is a block diagram of a system for aggregating memory, employing an expansion socket adapter, according to an embodiment of the present disclosure;

FIG. 1G is a block diagram of a system for disaggregating servers, according to an embodiment of the present disclosure;

FIG. 2 depicts a diagram of a representative system architecture in which aspects of the disclosed embodiments can operate in connection with a management computing entity that can communicate and configure the various servers described in connection with FIGS. 1A-1G, in accordance with example embodiments of the disclosure.

FIGS. 3A depicts a first diagram of representative system architectures in which aspects of the disclosed embodiments can operate in connection with a management computing entity that can communicate and configure the various servers described in connection with FIGS. 1A-1G, in accordance with example embodiments of the disclosure.

FIG. 3B depicts a second diagram of a representative system architecture in which aspects of the disclosed embodiments can operate in connection with a management computing entity that can communicate and configure the various servers described in connection with FIGS. 1A-1G, in accordance with example embodiments of the disclosure.

FIG. 3C depicts a third diagram of a representative system architecture in which aspects of the disclosed embodiments can operate in connection with a management computing entity that can communicate and configure the various servers described in connection with FIGS. 1A-1G, in accordance with example embodiments of the disclosure.

FIG. 3D depicts a fourth diagram of a representative system architecture in which aspects of the disclosed embodiments can operate in connection with a management computing entity that can communicate and configure the various servers described in connection with FIGS. 1A-1G, in accordance with example embodiments of the disclosure.

FIG. 4 depicts a diagram of a representative table of parameters that can characterize aspects of the servers described in connection with FIGS. 1A-1G, where the management computing entity configure the various servers based on the table of parameters, in accordance with example embodiments of the disclosure.

FIG. 5 depicts a diagram of a representative network architecture in which aspects of the disclosed embodiments can operate including embodiments where the management computing entity can configure servers in core, edge, and mobile edge data centers, in accordance with example embodiments of the disclosure.

FIG. 6 depicts another diagram of a representative network architecture in which aspects of the disclosed embodiments can operate including embodiments where the management computing entity can configure servers in core, edge, and mobile edge data centers, in accordance with example embodiments of the disclosure.

FIG. 7 depicts yet another diagram of a representative network architecture in which aspects of the disclosed embodiments can operate including embodiments where the management computing entity can configure servers in core, edge, and mobile edge data centers, in accordance with example embodiments of the disclosure.

FIG. 8 depicts a diagram of a supervised machine learning approach for determining distributions of workloads across different servers using the management computing entity, in accordance with example embodiments of the disclosure.

FIG. 9 depicts a diagram of an unsupervised machine learning approach for determining distributions of workloads across different servers using the management computing entity, in accordance with example embodiments of the disclosure.

FIG. 10 shows an example schematic diagram of a system that can be used to practice embodiments of the present disclosure.

FIG. 11 shows an example schematic diagram of a management computing entity, in accordance with example embodiments of the disclosure.

FIG. 12 shows an example schematic diagram of a user device, in accordance with example embodiments of the disclosure.

FIG. 13 is an illustration of an exemplary method 1300 of operating the disclosed systems to determine workload distributions across one or more clusters of a network, in accordance with example embodiments of the disclosure.

FIG. 14 is an illustration of an exemplary method 1400 of operating the disclosed systems to determine additional workload distributions across one or more clusters of a network, in accordance with example embodiments of the disclosure.

FIG. 15 is an illustration of an exemplary method 1500 of operating the disclosed systems to determine a distribution of a workload over one or more clusters of a network architecture, in accordance with example embodiments of the disclosure.

FIG. 16A is an illustration of an exemplary method 1600 of the disclosed systems to route the workload to one or more clusters of a core data center and one or more edge data centers over a network architecture, in accordance with example embodiments of the disclosure.

FIG. 16B is an illustration of another exemplary method 1601 of the disclosed systems to route the workload to one or more clusters of a core data center and one or more edge data centers over a network architecture, in accordance with example embodiments of the disclosure.

While the present techniques are susceptible to various modifications and alternative forms, specific embodiments thereof are shown by way of example in the drawings and will herein be described. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state component (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

In some aspects, networked computation and storage can face some problems with increasing data demands. In particular, hyperscale workload requirements are becoming more demanding, as workloads can exhibit diversity in memory and input/output (IO) latency in addition to having high bandwidth allocation needs. Further, some existing system can have reduced resource elasticity without reconfiguring hardware rack systems, which can lead to inefficiencies that can hamper data processing and storage requirements. Moreover, compute and memory resources are increasingly tightly coupled, and the increasing requirements for one can impact eh requirements for the other. Further, the industry as a whole is facing a shortage of feasible distributed shared memory and large address space systems. In some respects, fixed resources can add to the cost of ownership (e.g., for datacenter-based environments) and can also limit peak performance of subsystems. In some respects, the hardware used in such environments can have different replacement cycles and associated timelines, which can further complicate the updating of such systems. Accordingly, there is a need for improved sharing of resources and match to workloads in networked computing systems.

In some, cache coherent protocols such as compute express link (CXL) may enables memory extensions and coherent accelerators. In various embodiments, the disclosed systems can use a cache coherent protocol such as CXL to enable a class of memory systems and accelerators while accommodating different workloads need unique configurations. Accordingly, the disclosed systems can enable composable cache coherent (e.g., CXL) memory and accelerator resources by leveraging a fabric and architecture that presents a system view to each workload running across the racks, for example, in one or more clusters of a datacenter. In some respects, the disclosed systems can serve to extend cache coherence beyond a single server, provide management of heterogeneous racks based on workload demands, and provide composability of resources. Further, in some examples, CXL over PCIe fabric can act as s counterpart to another protocol such as Non-Volatile Memory express over fabric (NVMeoF), which can be used for remote I/O devices' composability. As used herein, composable can refer to a property through which a given device (e.g., a cache coherent enabled device in a particular cluster) can request and/or obtain resources (e.g., memory, compute, and/or network resources) from a different portion of the network (e.g., at least one other cache coherent enabled device in a second cluster), for example, to execute at least a portion of a workload. In some embodiments, composability, as used herein, can include the use of fluid pools of physical and virtual compute, storage, and fabric resources into any suitable configuration to run any application or workload.

In various embodiments, the disclosed systems can include one or more architecture components including a cache coherent CXL module with one or more processors (e.g., RISC-V processor(s)) which can be configured to execute various operations associated with a control plane. Further, the disclosed systems can enable the use of one or more homogenous pools of cache coherent CXL resources, to be discussed further below. In particular, the disclosed systems can feature a management computing device to expose and exploit performance and capacity and acceleration characteristics of the cache coherent resources for use by various network devices. In particular, the management computing device can determine one or more parameters associated with the system in which the management computing device operates and route workloads to different clusters based on the parameters.

In various embodiments, the disclosed systems can enable the use of multiple homogenous pools of resources, each pool being specialized for a specific cache coherent architecture. In particular, the disclosed systems can use a type-A cluster, which can refer to a collection of servers with direct attached memory extension devices (SCM, DRAM, DRAM-ZNAND hybrid), a Type-B cluster which can refer to a collection of CXL type-2 complaint coherent accelerators, a type-C cluster which can include CXL devices that are connected in a distributed memory system architecture with back-door PCIe interconnects whereby processes share the same address space, and type-D cluster including a physically cluster memory and accelerator extensions in the same structure (e.g., chassis).

In various embodiments, the disclosed systems including the management computing device can feature a smart-device architecture. In particular, the disclosed systems can feature a device that plugs onto a cache coherent interface (e.g., a CXL/PCIe5 interface) and can implement various cache and memory protocols (e.g., type-2 device based CXL.cache and CXL.memory protocols). Further, in some examples, the device can include a programmable controller or a processor (e.g., a RISC-V processor) that can be configured to present the remote coherent devices as part of the local system, negotiated using a cache coherent protocol (e.g., a CXL.IO protocol).

In various embodiments, the disclosed systems can enable a cluster-level performance-based control and management capability whereby workloads can be routed automatically (e.g., via an algorithmic approach and/or machine learning-based approach) based on remote architecture configurations and device performance, power characteristics, and/or the like. In some examples, the disclosed systems can be programmed at least partially via ASIC circuits, FPGA units, and/or the like. Further, such devices can implement an AI-based technique (e.g., a machine learning based methodology) to route the workloads as shown and described herein. Further, the disclosed systems can use the management computing entity to perform discovery and/or workload partitioning and/or resource binding based on a predetermined criterion (e.g., a best performance per unit of currency or power). Further, the management computing entity can perform such operations based on various parameters of the system including, but not limited to, a cache coherent protocol based (e.g., CXL based) round trip time, a determination of whether device is in host bias or device bias, a cache coherent protocol based (e.g., CXL based) switch hierarchy and/or a binding of host upstream ports to device downstream ports, a cache coherent protocol based (e.g., CXL based) switch fabric manager configuration, a cache coherent protocol based (e.g., CXL based) protocol packet or physical medium packet (e.g., a CXL.IO or PCIe intervening bulk 4KB packet), a network latency, a cache coherent protocol based (e.g., CXL based) memory technology (e.g., type of memory), combinations thereof, and/or the like.

In various embodiments, the management computing entity can operate at a rack and/or cluster level and/or may operate at least partially within a given device (e.g., cache-coherent enabled device) that is part of a given cluster architecture (e.g., types A, B, C, and/or D clusters). In various embodiments, the device within the given cluster architecture can perform a first portion of operations of the management computing entity while another portion of the operations of the management computing entity can be implemented on the rack and/or at the cluster level. In some embodiments, the two portions of operations can be performed in a coordinated manner (e.g., with the device in the cluster sending and receiving coordinating messages to and from the management computing entity implemented on the rack and/or at the cluster level). In some embodiments, the first portion of operations associated with the device in the cluster can include, but not be limited to, operations for determining a current or future resource need by the device or cluster, advertising a current or future resource availability by the device or cluster, synchronizing certain parameters associated with algorithms being run at the device or cluster level, training one or more machine learning modules associated with the device's or rack/cluster's operations, recording corresponding data associated with routing workloads, combinations thereof, and/or the like.

Peripheral Component Interconnect Express (PCIe) can refer to a computer interface which may have a relatively high and variable latency that can limit its usefulness in making connections to memory. CXL is an open industry standard for communications over PCIe 5.0, which can provide fixed, relatively short packet sizes, and, as a result, may be able to provide relatively high bandwidth and relatively low, fixed latency. As such, CXL may be capable of supporting cache coherence and CXL may be well suited for making connections to memory. CXL may further be used to provide connectivity between a host and accelerators, memory devices, and network interface circuits (or “network interface controllers” or network interface cards” (NICs)) in a server.

Cache coherent protocols such as CXL may also be employed for heterogeneous processing, e.g., in scalar, vector, and buffered memory systems. CXL may be used to leverage the channel, the retimers, the PHY layer of a system, the logical aspects of the interface, and the protocols from PCIe 5.0 to provide a cache-coherent interface. The CXL transaction layer may include three multiplexed sub-protocols that run simultaneously on a single link and can be referred to as CXL.io, CXL.cache, and CXL.memory. CXL.io may include I/O semantics, which may be similar to PCIe. CXL.cache may include caching semantics, and CXL.memory may include memory semantics; both the caching semantics and the memory semantics may be optional. Like PCIe, CXL may support (i) native widths of x16, x8, and x4, which may be partitionable, (ii) a data rate of 32 GT/s, degradable to 8 GT/s and 16 GT/s, 128b/130b, (iii) 300 W (75 W in a x16 connector), and (iv) plug and play. To support plug and play, either a PCIe or a CXL device link may start training in PCIe in Gen1, negotiate CXL, complete Gen 1-5 training and then start CXL transactions.

In some embodiments, the use of CXL connections to an aggregation, or “pool”, of memory (e.g., a quantity of memory, including a plurality of memory cells connected together) may provide various advantages, in a system that includes a plurality of servers connected together by a network, as discussed in further detail below. For example, a CXL switch having further capabilities in addition to providing packet-switching functionality for CXL packets (referred to herein as an “enhanced capability CXL switch”) may be used to connect the aggregation of memory to one or more central processing units (CPUs) (or “central processing circuits”) and to one or more network interface circuits (which may have enhanced capability). Such a configuration may make it possible (i) for the aggregation of memory to include various types of memory, having different characteristics, (ii) for the enhanced capability CXL switch to virtualize the aggregation of memory, and to store data of different characteristics (e.g., frequency of access) in appropriate types of memory, (iii) for the enhanced capability CXL switch to support remote direct memory access (RDMA) so that RDMA may be performed with little or no involvement from the server's processing circuits. As used herein, to “virtualize” memory means to perform memory address translation between the processing circuit and the memory.

A CXL switch may (i) support memory and accelerator dis-aggregation through single level switching, (ii) enable resources to be off-lined and on-lined between domains, which may enable time-multiplexing across domains, based on demand, and (iii) support virtualization of downstream ports. CXL may be employed to implement aggregated memory, which may enable one-to-many and many-to-one switching (e.g., it may be capable of (i) connecting multiple root ports to one end point, (ii) connecting one root port to multiple end points, or (iii) connecting multiple root ports to multiple end points), with aggregated devices being, in some embodiments, partitioned into multiple logical devices each with a respective LD-ID (logical device identifier). In such an embodiment a physical device may be partitioned into a plurality of logical devices, each visible to a respective initiator. A device may have one physical function (PF) and a plurality (e.g., 16) isolated logical devices. In some embodiments the number of logical devices (e.g., the number of partitions) may be limited (e.g. to 16), and one control partition (which may be a physical function used for controlling the device) may also be present.

In some embodiments, a fabric manager may be employed to (i) perform device discovery and virtual CXL software creation, and to (ii) bind virtual ports to physical ports. Such a fabric manager may operate through connections over an SMBus sideband. The fabric manager may be implemented in hardware, or software, or firmware, or in a combination thereof, and it may reside, for example, in the host, in one of the memory modules 135, or in the enhanced capability cache coherent switch 130, or elsewhere in the network. In some embodiment, the cache coherent switch may be a CXL switch 130. The fabric manager may issue commands including commands issued through a sideband bus or through the PCIe tree.

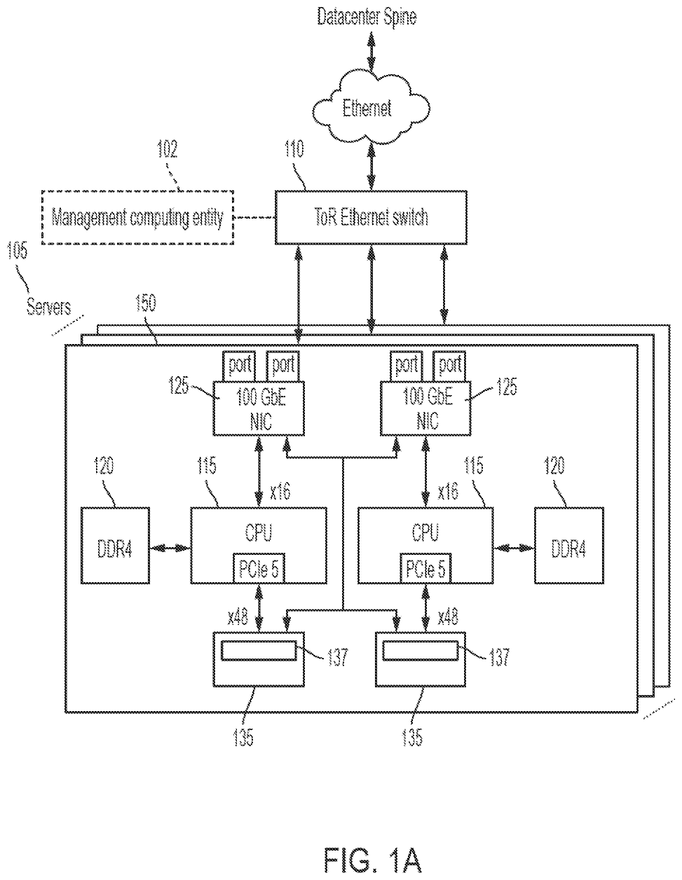

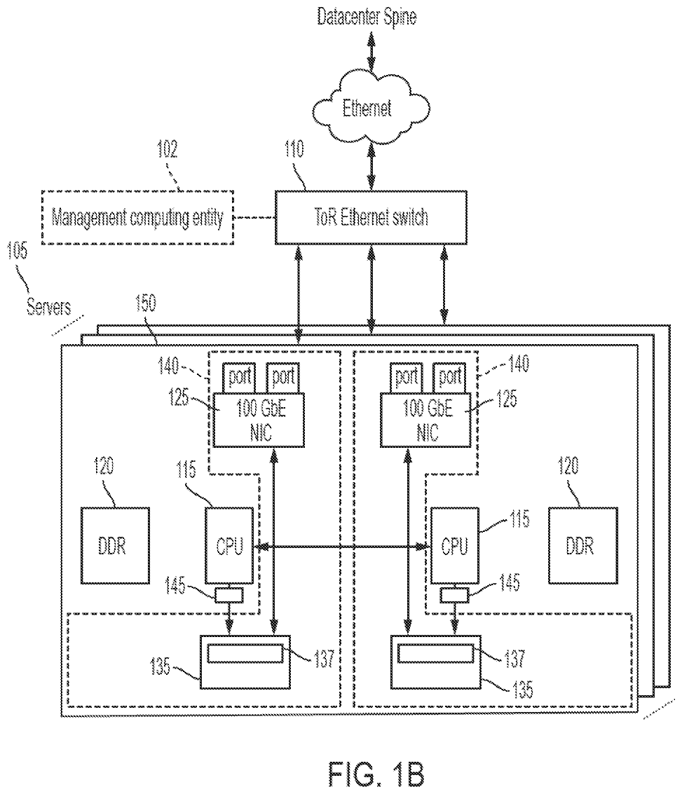

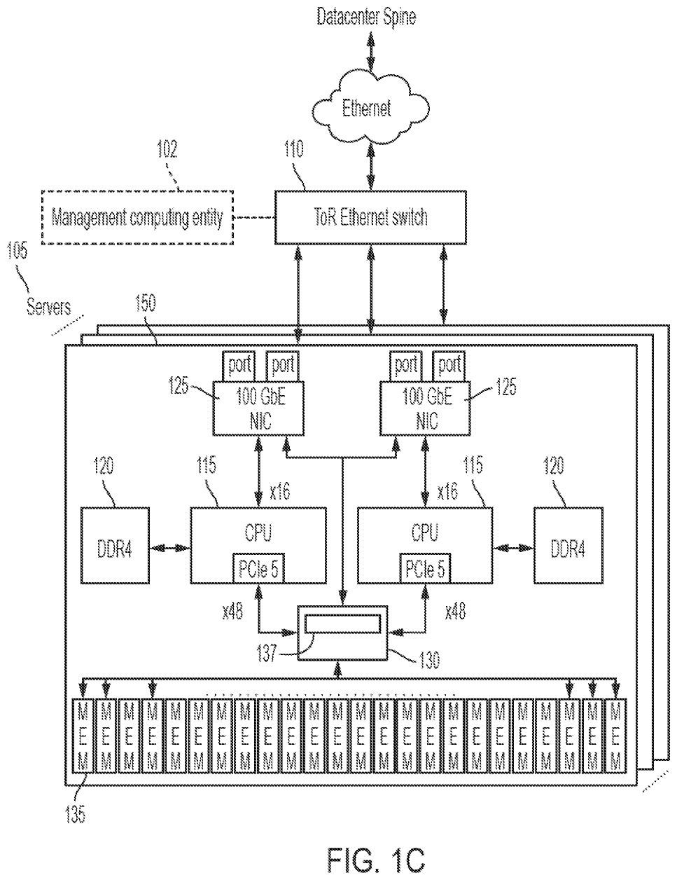

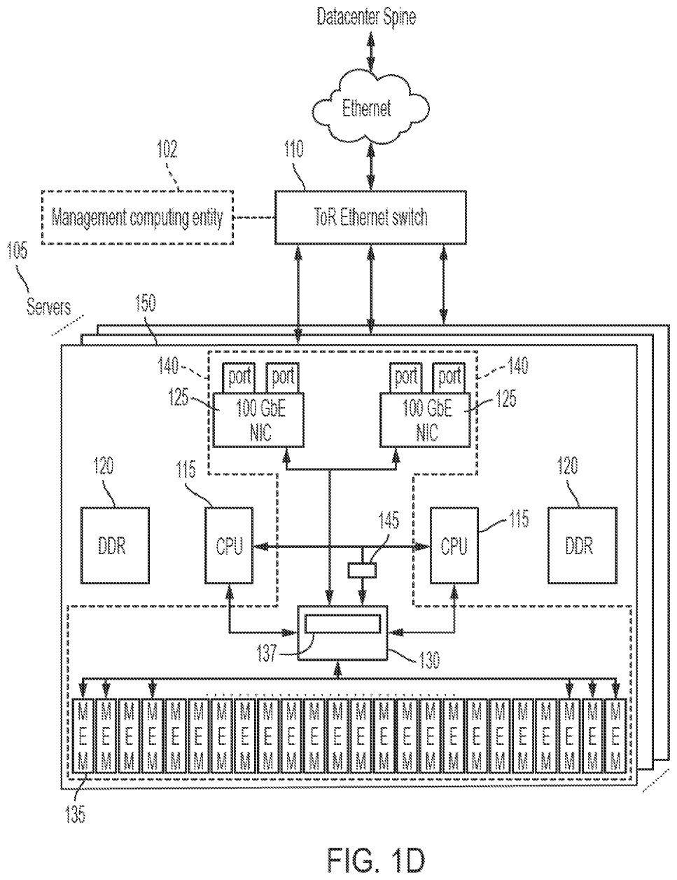

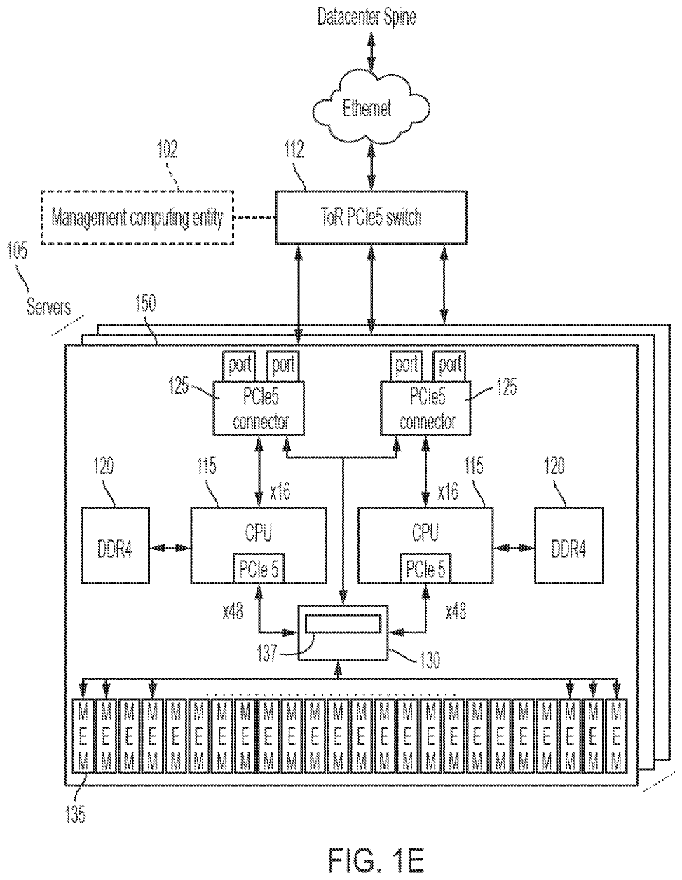

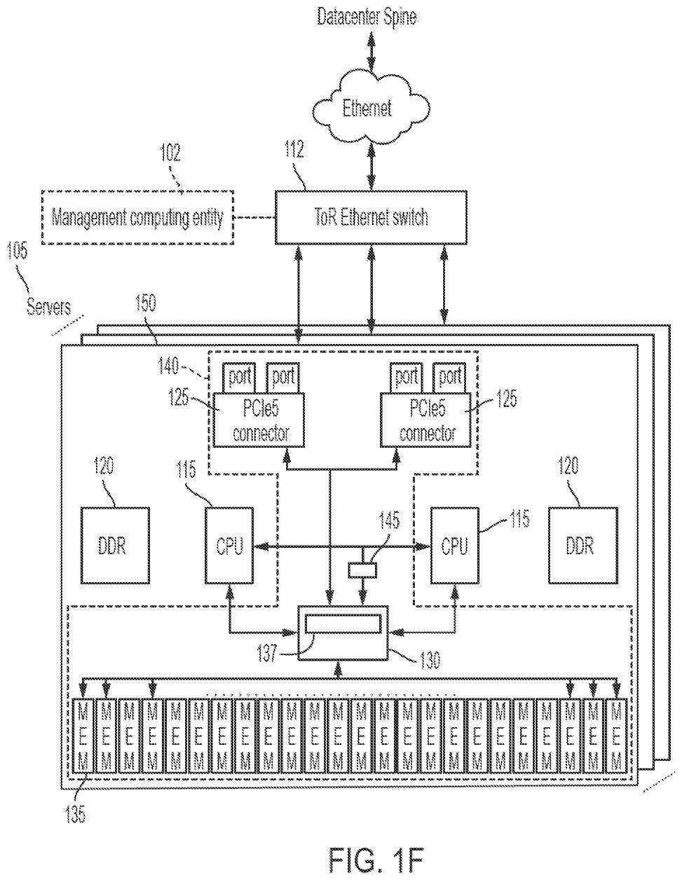

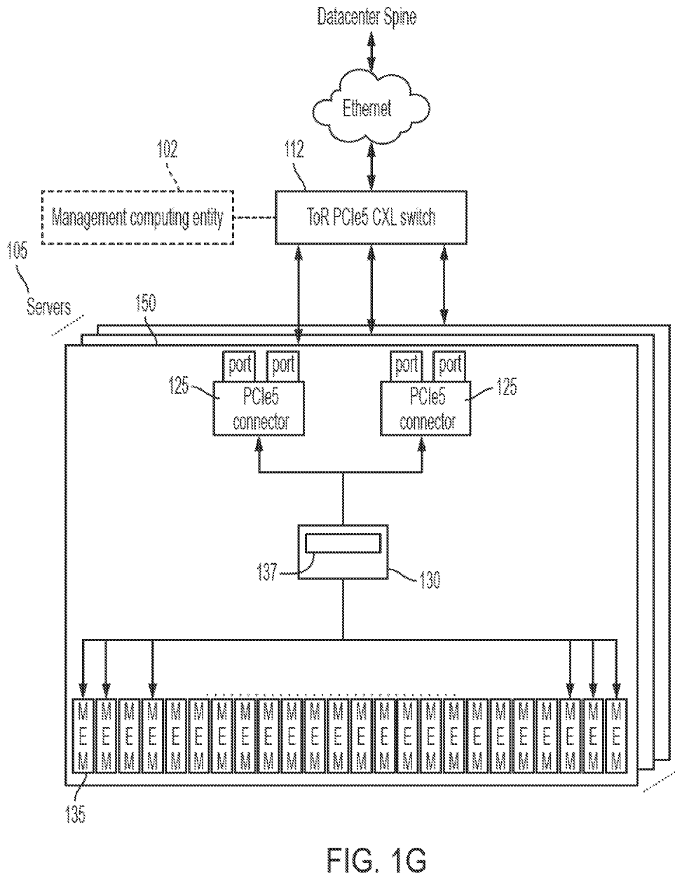

Referring to FIG. 1A, in some embodiments, a server system includes a plurality of servers 105, connected together by a top of rack (ToR) Ethernet switch 110. While this switch is described as using Ethernet protocol, any other suitable network protocol may be used. Each server includes one or more processing circuits 115, each connected to (i) system memory 120 (e.g., Double Data Rate (version 4) (DDR4) memory or any other suitable memory), (ii) one or more network interface circuits 125, and (iii) one or more CXL memory modules 135. Each of the processing circuits 115 may be a stored-program processing circuit, e.g., a central processing unit (CPU (e.g., an x86 CPU), a graphics processing unit (GPU), or an ARM processor. In some embodiments a network interface circuit 125 may be embedded in (e.g., on the same semiconductor chip as, or in the same module as) one of the memory modules 135, or a network interface circuit 125 may be separately packaged from the memory modules 135.

In various embodiments, a management computing entity 102 (to be described below in detail) can be configured to include a processing element (e.g., a processor, FPGA, ASIC, controller, etc.) that can monitor one or more parameters associated with any portion of the network (e.g., the Ethernet traffic, data center parameters, ToR Ethernet switch 110 parameters, parameters associated with servers 105, network interface circuit (NIC) 125 associated parameters, one or more CXL memory modules 135 associated parameters, combinations thereof, and/or the like) to route workloads and/or portions of workloads to different portions of the network, including any suitable element of FIGS. 1A-1G, described herein. Further, noted above, in various embodiments, the disclosed systems can enable a cluster-level performance-based control and management capability whereby workloads can be routed automatically (e.g., via an algorithmic approach and/or machine learning-based approach) based on remote architecture configurations and device performance, power characteristics, and/or the like. In some examples, the disclosed systems can be programmed at least partially via ASIC circuits, FPGA units, and/or the like. Further, such devices can implement an AI-based technique (e.g., a machine learning based methodology) to route the workloads as shown and described herein. Further, the disclosed systems can use the management computing entity to perform discovery and/or workload partitioning and/or resource binding based on a predetermined criterion (e.g., a best performance per unit of currency or power). Further, the management computing entity can perform such operations based on various parameters of the system including, but not limited to, a cache coherent protocol based (e.g., CXL based) round trip time, a determination of whether device is in host bias or device bias, a cache coherent protocol based (e.g., CXL based) switch hierarchy and/or a binding of host upstream ports to device downstream ports, a cache coherent protocol based (e.g., CXL based) switch fabric manager configuration, a cache coherent protocol based (e.g., CXL based) protocol packet or physical medium packet (e.g., a CXL.IO or PCIe intervening bulk 4 KB packet), a network latency, a cache coherent protocol based (e.g., CXL based) memory technology (e.g., type of memory), combinations thereof, and/or the like.

As used herein, a “memory module” is a package (e.g., a package including a printed circuit board and components connected to it, or an enclosure including a printed circuit board) including one or more memory dies, each memory die including a plurality of memory cells. Each memory die, or each of a set of groups of memory dies, may be in a package (e.g., an epoxy mold compound (EMC) package) soldered to the printed circuit board of the memory module (or connected to the printed circuit board of the memory module through a connector). Each of the memory modules 135 may have a CXL interface and may include a controller 137 (e.g., an FPGA, an ASIC, a processor, and/or the like) for translating between CXL packets and the memory interface of the memory dies, e.g., the signals suitable for the memory technology of the memory in the memory module 135. As used herein, the “memory interface” of the memory dies is the interface that is native to the technology of the memory dies, e.g., in the case of DRAM e.g., the memory interface may be word lines and bit lines. A memory module may also include a controller 137 which may provide enhanced capabilities, as described in further detail below. The controller 137 of each memory modules 135 may be connected to a processing circuit 115 through a cache-coherent interface, e.g., through the CXL interface. The controller 137 may also facilitate data transmissions (e.g., RDMA requests) between different servers 105, bypassing the processing circuits 115. The ToR Ethernet switch 110 and the network interface circuits 125 may include an RDMA interface to facilitate RDMA requests between CXL memory devices on different servers (e.g., the ToR Ethernet switch 110 and the network interface circuits 125 may provide hardware offload or hardware acceleration of RDMA over Converged Ethernet (RoCE), Infiniband, and iWARP packets).

The CXL interconnects in the system may comply with a cache coherent protocol such as the CXL 1.1 standard, or, in some embodiments, with the CXL 2.0 standard, with a future version of CXL, or any other suitable protocol (e.g., cache coherent protocol). The memory modules 135 may be directly attached to the processing circuits 115 as shown, and the top of rack Ethernet switch 110 may be used for scaling the system to larger sizes (e.g., with larger numbers of servers 105).

In some embodiments, each server can be populated with multiple direct-attached CXL attached memory modules 135, as shown in FIG. 1A. Each memory module 135 may expose a set of base address registers (BARs) to the host's Basic Input/Output System (BIOS) as a memory range. One or more of the memory modules 135 may include firmware to transparently manage its memory space behind the host OS map. Each of the memory modules 135 may include one of, or a combination of, memory technologies including, for example (but not limited to) Dynamic Random Access Memory (DRAM), not-AND (NAND) flash, High Bandwidth Memory (HBM), and Low-Power Double Data Rate Synchronous Dynamic Random Access Memory (LPDDR SDRAM) technologies, and may also include a cache controller or separate respective split controllers for different technology memory devices (for memory modules 135 that combine several memory devices of different technologies). Each memory module 135 may include different interface widths (x4-x16), and may be constructed according to any of various pertinent form factors, e.g., U.2, M.2, half height, half length (HHHL), full height, half length (FHHL), E1.S, E1.L, E3.S, and E3.H.

In some embodiments, as mentioned above, the enhanced capability CXL switch 130 includes an FPGA (or ASIC) controller 137 and provides additional features beyond switching of CXL packets. The controller 137 of the enhanced capability CXL switch 130 may also act as a management device for the memory modules 135 and help with host control plane processing, and it may enable rich control semantics and statistics. The controller 137 may include an additional “backdoor” (e.g., 100 gigabit Ethernet (GbE)) network interface circuit 125. In some embodiments, the controller 137 presents as a CXL Type 2 device to the processing circuits 115, which enables the issuing of cache invalidate instructions to the processing circuits 115 upon receiving remote write requests. In some embodiments, DDIO technology is enabled, and remote data is first pulled to last level cache (LLC) of the processing circuit and later written to the memory modules 135 (from cache). As used herein, a “Type 2” CXL Device is one that can initiate transactions and that implements an optional coherent cache and host-managed device memory and for which applicable transaction types include all CXL.cache and all CXL.memory transactions.

As mentioned above, one or more of the memory modules 135 may include persistent memory, or “persistent storage” (i.e., storage within which data is not lost when external power is disconnected). If a memory module 135 is presented as a persistent device, the controller 137 of the memory module 135 may manage the persistent domain, e.g., it may store, in the persistent storage data identified (e.g., as a result of an application making a call to a corresponding operating system function) by a processing circuit 115 as requiring persistent storage. In such an embodiment, a software API may flush caches and data to the persistent storage.

In some embodiments, direct memory transfer to the memory modules 135 from the network interface circuits 125 is enabled. Such transfers may be a one-way transfers to remote memory for fast communication in a distributed system. In such an embodiment, the memory modules 135 may expose hardware details to the network interface circuits 125 in the system to enable faster RDMA transfers. In such a system, two scenarios may occur, depending on whether the Data Direct I/O (DDIO) of the processing circuit 115 is enabled or disabled. DDIO may enable direct communication between an Ethernet controller or an Ethernet adapter and a cache of a processing circuit 115. If the DDIO of the processing circuit 115 is enabled, the transfer's target may be the last level cache of the processing circuit, from which the data may subsequently be automatically flushed to the memory modules 135. If the DDIO of the processing circuit 115 is disabled, the memory modules 135 may operate in device-bias mode to force accesses to be directly received by the destination memory module 135 (without DDIO). An RDMA-capable network interface circuit 125 with host channel adapter (HCA), buffers, and other processing, may be employed to enable such an RDMA transfer, which may bypass the target memory buffer transfer that may be present in other modes of RDMA transfer. For example, in such an embodiment, the use of a bounce buffer (e.g., a buffer in the remote server, when the eventual destination in memory is in an address range not supported by the RDMA protocol) may be avoided. In some embodiments, RDMA uses another physical medium option, other than Ethernet (e.g., for use with a switch that is configured to handle other network protocols). Examples of inter-server connections that may enable RDMA include (but are not limited to) Infiniband, RDMA over Converged Ethernet (RoCE) (which uses Ethernet User Datagram Protocol (UDP)), and iWARP (which uses transmission control protocol/Internet protocol (TCP/IP)).

FIG. 1B shows a system similar to that of FIG. 1A, in which the processing circuits 115 are connected to the network interface circuits 125 through the memory modules 135. The memory modules 135 and the network interface circuits 125 are on expansion socket adapters 140. Each expansion socket adapter 140 may plug into an expansion socket 145, e.g., a M.2 connector, on the motherboard of the server 105. As such, the server may be any suitable (e.g., industry standard) server, modified by the installation of the expansion socket adapters 140 in expansion sockets 145. In such an embodiment, (i) each network interface circuit 125 may be integrated into a respective one of the memory modules 135, or (ii) each network interface circuit 125 may have a PCIe interface (the network interface circuit 125 may be a PCIe endpoint (i.e., a PCIe slave device)), so that the processing circuit 115 to which it is connected (which may operate as the PCIe master device, or “root port”) may communicate with it through a root port to endpoint PCIe connection, and the controller 137 of the memory module 135 may communicate with it through a peer-to-peer PCIe connection.

According to an embodiment of the present invention, there is provided a system, including: a first server, including: a stored-program processing circuit, a first network interface circuit, and a first memory module, wherein: the first memory module includes: a first memory die, and a controller, the controller being connected: to the first memory die through a memory interface, to the stored-program processing circuit through a cache-coherent interface, and to the first network interface circuit. In some embodiments: the first memory module further includes a second memory die, the first memory die includes volatile memory, and the second memory die includes persistent memory. In some embodiments, the persistent memory includes NAND flash. In some embodiments, the controller is configured to provide a flash translation layer for the persistent memory. In some embodiments, the cache-coherent interface includes a Compute Express Link (CXL) interface. In some embodiments, the first server includes an expansion socket adapter, connected to an expansion socket of the first server, the expansion socket adapter including: the first memory module; and the first network interface circuit. In some embodiments, the controller of the first memory module is connected to the stored-program processing circuit through the expansion socket. In some embodiments, the expansion socket includes an M.2 socket. In some embodiments, the controller of the first memory module is connected to the first network interface circuit by a peer to peer Peripheral Component Interconnect Express (PCIe) connection. In some embodiments, the system further includes: a second server, and a network switch connected to the first server and to the second server. In some embodiments, the network switch includes a top of rack (ToR) Ethernet switch. In some embodiments, the controller of the first memory module is configured to receive straight remote direct memory access (RDMA) requests, and to send straight RDMA responses. In some embodiments, the controller of the first memory module is configured to receive straight remote direct memory access (RDMA) requests through the network switch and through the first network interface circuit, and to send straight RDMA responses through the network switch and through the first network interface circuit. In some embodiments, the controller of the first memory module is configured to: receive data, from the second server; store the data in the first memory module; and send, to the stored-program processing circuit, a command for invalidating a cache line. In some embodiments, the controller of the first memory module includes a field programmable gate array (FPGA) or an application-specific integrated circuit (ASIC). According to an embodiment of the present invention, there is provided a method for performing remote direct memory access in a computing system, the computing system including: a first server and a second server, the first server including: a stored-program processing circuit, a network interface circuit, and a first memory module including a controller, the method including: receiving, by the controller of the first memory module, a straight remote direct memory access (RDMA) request; and sending, by the controller of the first memory module, a straight RDMA response. In some embodiments: the computing system further includes an Ethernet switch connected to the first server and to the second server, and the receiving of the straight RDMA request includes receiving the straight RDMA request through the Ethernet switch. In some embodiments, the method further includes: receiving, by the controller of the first memory module, a read command, from the stored-program processing circuit, for a first memory address, translating, by the controller of the first memory module, the first memory address to a second memory address, and retrieving, by the controller of the first memory module, data from the first memory module at the second memory address. In some embodiments, the method further includes: receiving data, by the controller of the first memory module, storing, by the controller of the first memory module, the data in the first memory module, and sending, by the controller of the first memory module, to the stored-program processing circuit, a command for invalidating a cache line. According to an embodiment of the present invention, there is provided a system, including: a first server, including: a stored-program processing circuit, a first network interface circuit, and a first memory module, wherein: the first memory module includes: a first memory die, and controller means, the controller means being connected: to the first memory die through a memory interface, to the stored-program processing circuit through a cache-coherent interface, and to the first network interface circuit.

Referring to FIG. 1C, in some embodiments, a server system includes a plurality of servers 105, connected together by a top of rack (ToR) Ethernet switch 110. Each server includes one or more processing circuits 115, each connected to (i) system memory 120 (e.g., DDR4 memory), (ii) one or more network interface circuits 125, and (iii) an enhanced capability CXL switch 130. The enhanced capability CXL switch 130 may be connected to a plurality of memory modules 135. That is, the system of FIG. 1C includes a first server 105, including a stored-program processing circuit 115, a network interface circuit 125, a cache-coherent switch 130, and a first memory module 135. In the system of FIG. 1C, the first memory module 135 is connected to the cache-coherent switch 130, the cache-coherent switch 130 is connected to the network interface circuit 125, and the stored-program processing circuit 115 is connected to the cache-coherent switch 130.

The memory modules 135 may be grouped by type, form factor, or technology type (e.g., DDR4, DRAM, LDPPR, high bandwidth memory (HBM), or NAND flash, or other persistent storage (e.g., solid state drives incorporating NAND flash)). Each memory module may have a CXL interface and include an interface circuit for translating between CXL packets and signals suitable for the memory in the memory module 135. In some embodiments, these interface circuits are instead in the enhanced capability CXL switch 130, and each of the memory modules 135 has an interface that is the native interface of the memory in the memory module 135. In some embodiments, the enhanced capability CXL switch 130 is integrated into (e.g., in an M.2 form factor package with, or integrated into a single integrated circuit with other components of) a memory module 135.

The ToR Ethernet switch 110 may include interface hardware to facilitate RDMA requests between aggregated memory devices on different servers. The enhanced capability CXL switch 130 may include one or more circuits (e.g., it may include an FPGA or an ASIC) to (i) route data to different memory types based on workload (ii) virtualize host addresses to device addresses and/or (iii) facilitate RDMA requests between different servers, bypassing the processing circuits 115.

The memory modules 135 may be in an expansion box (e.g., in the same rack as the enclosure housing the motherboard of the enclosure), which may include a predetermined number (e.g., more than 20 or more than 100) memory modules 135, each plugged into a suitable connector. The modules may be in an M.2 form factor, and the connectors may be M.2 connectors. In some embodiments, the connections between servers are over a different network, other than Ethernet, e.g., they may be wireless connections such as WiFi or 5G connections. Each processing circuit may be an x86 processor or another processor, e.g., an ARM processor or a GPU. The PCIe links on which the CXL links are instantiated may be PCIe 5.0 or another version (e.g., an earlier version or a later (e.g., future) version (e.g., PCIe 6.0). In some embodiments, a different cache-coherent protocol is used in the system instead of, or in addition to, CXL, and a different cache coherent switch may be used instead of, or in addition to, the enhanced capability CXL switch 130. Such a cache coherent protocol may be another standard protocol or a cache coherent variant of the standard protocol (in a manner analogous to the manner in which CXL is a variant of PCIe 5.0). Examples of standard protocols include, but are not limited to, non-volatile dual in-line memory module (version P) (NVDIMM-P), Cache Coherent Interconnect for Accelerators (CCIX), and Open Coherent Accelerator Processor Interface (OpenCAPI).

The system memory 120 may include, e.g., DDR4 memory, DRAM, HBM, or LDPPR memory. The memory modules 135 may be partitioned or contain cache controllers to handle multiple memory types. The memory modules 135 may be in different form factors, examples of which include but are not limited to HHHL, FHHL, M.2, U.2, mezzanine card, daughter card, E1.S, E1.L, E3.L, and E3.S.

In some embodiments, the system implements an aggregated architecture, including multiple servers, with each server aggregated with multiple CXL-attached memory modules 135. Each of the memory modules 135 may contain multiple partitions that can separately be exposed as memory devices to multiple processing circuits 115. Each input port of the enhanced capability CXL switch 130 may independently access multiple output ports of the enhanced capability CXL switch 130 and the memory modules 135 connected thereto. As used herein, an “input port” or “upstream port” of the enhanced capability CXL switch 130 is a port connected to (or suitable for connecting to) a PCIe root port, and an “output port” or “downstream port” of the enhanced capability CXL switch 130 is a port connected to (or suitable for connecting to) a PCIe endpoint. As in the case of the embodiment of FIG. 1A, each memory module 135 may expose a set of base address registers (BARs) to host BIOS as a memory range. One or more of the memory modules 135 may include firmware to transparently manage its memory space behind the host OS map.

In some embodiments, as mentioned above, the enhanced capability CXL switch 130 includes an FPGA (or ASIC) controller 137 and provides additional features beyond switching of CXL packets. For example, it may (as mentioned above) virtualize the memory modules 135, i.e., operate as a translation layer, translating between processing circuit-side addresses (or “processor-side” addresses, i.e., addresses that are included in memory read and write commands issued by the processing circuits 115) and memory-side addresses (i.e., addresses employed by the enhanced capability CXL switch 130 to address storage locations in the memory modules 135), thereby masking the physical addresses of the memory modules 135 and presenting a virtual aggregation of memory. The controller 137 of the enhanced capability CXL switch 130 may also act as a management device for the memory modules 135 and facilitate with host control plane processing. The controller 137 may transparently move data without the participation of the processing circuits 115 and accordingly update the memory map (or “address translation table”) so that subsequent accesses function as expected. The controller 137 may contain a switch management device that (i) can bind and unbind the upstream and downstream connections during runtime as appropriate, and (iii) can enable rich control semantics and statistics associated with data transfers into and out of the memory modules 135. The controller 137 may include an additional “backdoor” 100 GbE or other network interface circuit 125 (in addition to the network interface used to connect to the host) for connecting to other servers 105 or to other networked equipment. In some embodiments, the controller 137 presents as a Type 2 device to the processing circuits 115, which enables the issuing of cache invalidate instructions to the processing circuits 115 upon receiving remote write requests. In some embodiments, DDIO technology is enabled, and remote data is first pulled to last level cache (LLC) of the processing circuit 115 and later written to the memory modules 135 (from cache).

As mentioned above, one or more of the memory modules 135 may include persistent storage. If a memory module 135 is presented as a persistent device, the controller 137 of the enhanced capability CXL switch 130 may manage the persistent domain (e.g., it may store, in the persistent storage, data identified (e.g., by the use of a corresponding operating system function) by a processing circuit 115 as requiring persistent storage. In such an embodiment, a software API may flush caches and data to the persistent storage.

In some embodiments, direct memory transfer to the memory modules 135 may be performed in a manner analogous to that described above for the embodiment of FIGS. 1A and 1B, with operations performed by the controllers of the memory modules 135 being, performed by the controller 137 of the enhanced capability CXL switch 130.

As mentioned above, in some embodiments, the memory modules 135 are organized into groups, e.g., into one group which is memory intensive, another group which is HBM heavy, another group which has limited density and performance, and another group that has a dense capacity. Such groups may have different form factors or be based on different technologies. The controller 137 of the enhanced capability CXL switch 130 may route data and commands intelligently based on, for example, a workload, a tagging, or a quality of service (QoS). For read requests, there may be no routing based on such factors.

The controller 137 of the enhanced capability CXL switch 130 may also (as mentioned above) virtualize the processing-circuit-side addresses and memory-side addresses, making it possible for the controller 137 of the enhanced capability CXL switch 130 to determine where data is to be stored. The controller 137 of the enhanced capability CXL switch 130 may make such a determination based on information or instructions it may receive from a processing circuit 115. For example, the operating system may provide a memory allocation feature making it possible for an application to specify that low-latency storage, or high bandwidth storage, or persistent storage is to be allocated, and such a request, initiated by the application, may then be taken into account by the controller 137 of the enhanced capability CXL switch 130 in determining where (e.g. in which of the memory modules 135) to allocate the memory. For example, storage for which high bandwidth is requested by the application may be allocated in memory modules 135 containing HBM, storage for which data persistence is requested by the application may be allocated in memory modules 135 containing NAND flash, and other storage (for which the application has made no requests) may be stored on memory modules 135 containing relatively inexpensive DRAM. In some embodiments, the controller 137 of the enhanced capability CXL switch 130 may make determinations about where to store certain data based on network usage patterns. For example, the controller 137 of the enhanced capability CXL switch 130 may determine, by monitoring usage patterns, that data in a certain range of physical addresses are being accessed more frequently than other data, and the controller 137 of the enhanced capability CXL switch 130 may then copy these data into a memory module 135 containing HBM, and modify its address translation table so that the data, in the new location, are stored in the same range of virtual addresses. In some embodiments one or more of the memory modules 135 includes flash memory (e.g., NAND flash), and the controller 137 of the enhanced capability CXL switch 130 implements a flash translation layer for this flash memory. The flash translation layer may support overwriting of processor-side memory locations (by moving the data to a different location and marking the previous location of the data as invalid) and it may perform garbage collection (e.g., erasing a block, after moving, to another block, any valid data in the block, when the fraction of data in the block marked invalid exceeds a threshold).

In some embodiments, the controller 137 of the enhanced capability CXL switch 130 may facilitate a physical function (PF) to PF transfer. For example, if one of the processing circuits 115 needs to move data from one physical address to another (which may have the same virtual addresses; this fact need not affect the operation of the processing circuit 115), or if the processing circuit 115 needs to move data between two virtual addresses (which the processing circuit 115 would need to have) the controller 137 of the enhanced capability CXL switch 130 may supervise the transfer, without the involvement of the processing circuit 115. For example, the processing circuit 115 may send a CXL request, and data may be transmitted from one memory module 135 to another memory module 135 (e.g., the data may be copied from one memory module 135 to another memory module 135) behind the enhanced capability CXL switch 130 without going to the processing circuit 115. In this situation, because the processing circuit 115 initiated the CXL request, the processing circuit 115 may need to flush its cache to ensure consistency. If instead a Type 2 memory device (e.g., one of the memory modules 135, or an accelerator that may also be connected to the CXL switch) initiates the CXL request and the switch is not virtualized, then the Type 2 memory device may send a message to the processing circuit 115 to invalidate the cache.

In some embodiments, the controller 137 of the enhanced capability CXL switch 130 may facilitate RDMA requests between servers. A remote server 105 may initiate such an RDMA request, and the request may be sent through the ToR Ethernet switch 110, and arrive at the enhanced capability CXL switch 130 in the server 105 responding to the RDMA request (the “local server”). The enhanced capability CXL switch 130 may be configured to receive such an RDMA request and it may treat a group of memory modules 135 in the receiving server 105 (i.e., the server receiving the RDMA request) as its own memory space. In the local server, the enhanced capability CXL switch 130 may receive the RDMA request as a direct RDMA request (i.e., an RDMA request that is not routed through a processing circuit 115 in the local server) and it may send a direct response to the RDMA request (i.e., it may send the response without it being routed through a processing circuit 115 in the local server). In the remote server, the response (e.g., data sent by the local server) may be received by the enhanced capability CXL switch 130 of the remote server, and stored in the memory modules 135 of the remote server, without being routed through a processing circuit 115 in the remote server.

FIG. 1D shows a system similar to that of FIG. 1C, in which the processing circuits 115 are connected to the network interface circuits 125 through the enhanced capability CXL switch 130. The enhanced capability CXL switch 130, the memory modules 135, and the network interface circuits 125 are on an expansion socket adapter 140. The expansion socket adapter 140 may be a circuit board or module that plugs into an expansion socket, e.g., a PCIe connector 145, on the motherboard of the server 105. As such, the server may be any suitable server, modified only by the installation of the expansion socket adapter 140 in the PCIe connector 145. The memory modules 135 may be installed in connectors (e.g., M.2 connectors) on the expansion socket adapter 140. In such an embodiment, (i) the network interface circuits 125 may be integrated into the enhanced capability CXL switch 130, or (ii) each network interface circuit 125 may have a PCIe interface (the network interface circuit 125 may be a PCIe endpoint), so that the processing circuit 115 to which it is connected may communicate with the network interface circuit 125 through a root port to endpoint PCIe connection. The controller 137 of the enhanced capability CXL switch 130 (which may have a PCIe input port connected to the processing circuit 115 and to the network interface circuits 125) may communicate with the network interface circuit 125 through a peer-to-peer PCIe connection.

According to an embodiment of the present invention, there is provided a system, including: a first server, including: a stored-program processing circuit, a network interface circuit, a cache-coherent switch, and a first memory module, wherein: the first memory module is connected to the cache-coherent switch, the cache-coherent switch is connected to the network interface circuit, and the stored-program processing circuit is connected to the cache-coherent switch. In some embodiments, the system further includes a second memory module connected to the cache-coherent switch, wherein the first memory module includes volatile memory and the second memory module includes persistent memory. In some embodiments, the cache-coherent switch is configured to virtualize the first memory module and the second memory module. In some embodiments, the first memory module includes flash memory, and the cache-coherent switch is configured to provide a flash translation layer for the flash memory. In some embodiments, the cache-coherent switch is configured to: monitor an access frequency of a first memory location in the first memory module; determine that the access frequency exceeds a first threshold; and copy the contents of the first memory location into a second memory location, the second memory location being in the second memory module. In some embodiments, the second memory module includes high bandwidth memory (HBM). In some embodiments, the cache-coherent switch is configured to maintain a table for mapping processor-side addresses to memory-side addresses. In some embodiments, the system further includes: a second server, and a network switch connected to first server and the second server. In some embodiments, the network switch includes a top of rack (ToR) Ethernet switch. In some embodiments, the cache-coherent switch is configured to receive straight remote direct memory access (RDMA) requests, and to send straight RDMA responses. In some embodiments, the cache-coherent switch is configured to receive the remote direct memory access (RDMA) requests through the ToR Ethernet switch and through the network interface circuit, and to send straight RDMA responses through the ToR Ethernet switch and through the network interface circuit. In some embodiments, the cache-coherent switch is configured to support a Compute Express Link (CXL) protocol. In some embodiments, the first server includes an expansion socket adapter, connected to an expansion socket of the first server, the expansion socket adapter including: the cache-coherent switch; and a memory module socket, the first memory module being connected to the cache-coherent switch through the memory module socket. In some embodiments, the memory module socket includes an M.2 socket. In some embodiments, the network interface circuit is on the expansion socket adapter. According to an embodiment of the present invention, there is provided a method for performing remote direct memory access in a computing system, the computing system including: a first server and a second server, the first server including: a stored-program processing circuit, a network interface circuit, a cache-coherent switch, and a first memory module, the method including: receiving, by the cache-coherent switch, a straight remote direct memory access (RDMA) request, and sending, by the cache-coherent switch, a straight RDMA response. In some embodiments: the computing system further includes an Ethernet switch, and the receiving of the straight RDMA request includes receiving the straight RDMA request through the Ethernet switch. In some embodiments, the method further includes: receiving, by the cache-coherent switch, a read command, from the stored-program processing circuit, for a first memory address, translating, by the cache-coherent switch, the first memory address to a second memory address, and retrieving, by the cache-coherent switch, data from the first memory module at the second memory address. In some embodiments, the method further includes: receiving data, by the cache-coherent switch, storing, by the cache-coherent switch, the data in the first memory module, and sending, by the cache-coherent switch, to the stored-program processing circuit, a command for invalidating a cache line. According to an embodiment of the present invention, there is provided a system, including: a first server, including: a stored-program processing circuit, a network interface circuit, cache-coherent switching means, and a first memory module, wherein: the first memory module is connected to the cache-coherent switching means, the cache-coherent switching means is connected to the network interface circuit, and the stored-program processing circuit is connected to the cache-coherent switching means.

FIG. 1E shows an embodiment in which each of a plurality of servers 105 is connected to a ToR server-linking switch 112, which may be a PCIe 5.0 CXL switch, having PCIe capabilities, as illustrated. The server-linking switch 112 may include an FPGA or ASIC, and may provide performance (in terms of throughput and latency) superior to that of an Ethernet switch. Each of the servers 105 may include a plurality of memory modules 135 connected to the server-linking switch 112 through the enhanced capability CXL switch 130 and through a plurality of PCIe connectors. Each of the servers 105 may also include one or more processing circuits 115, and system memory 120, as shown. The server-linking switch 112 may operate as a master, and each of the enhanced capability CXL switches 130 may operate as a slave, as discussed in further detail below.

In the embodiment of FIG. 1E, the server-linking switch 112 may group or batch multiple cache requests received from different servers 105, and it may group packets, reducing control overhead. The enhanced capability CXL switch 130 may include a slave controller (e.g., a slave FPGA or a slave ASIC) to (i) route data to different memory types based on workload, (ii) virtualize processor-side addresses to memory-side addresses, and (iii) facilitate coherent requests between different servers 105, bypassing the processing circuits 115. The system illustrated in FIG. 1E may be CXL 2.0 based, it may include distributed shared memory within a rack, and it may use the ToR server-linking switch 112 to natively connect with remote nodes.

The ToR server-linking switch 112 may have an additional network connection (e.g., an Ethernet connection, as illustrated, or another kind of connection, e.g., a wireless connection such as a WiFi connection or a 5G connection) for making connections to other servers or to clients. The server-linking switch 112 and the enhanced capability CXL switch 130 may each include a controller, which may be or include a processing circuit such as an ARM processor. The PCIe interfaces may comply with the PCIe 5.0 standard or with an earlier version, or with a future version of the PCIe standard, or interfaces complying with a different standard (e.g., NVDIMM-P, CCIX, or OpenCAPI) may be employed instead of PCIe interfaces. The memory modules 135 may include various memory types including DDR4 DRAM, HBM, LDPPR, NAND flash, or solid state drives (SSDs). The memory modules 135 may be partitioned or contain cache controllers to handle multiple memory types, and they may be in different form factors, such as HHHL, FHHL, M.2, U.2, mezzanine card, daughter card, E1.S, E1.L, E3.L, or E3.S.

In the embodiment of FIG. 1E, the enhanced capability CXL switch 130 may enable one-to-many and many-to-one switching, and it may enable a fine grain load-store interface at the flit (64-byte) level. Each server may have aggregated memory devices, each device being partitioned into multiple logical devices each with a respective LD-ID. A ToR switch 112 (which may be referred to as a “server-linking switch” enables the one-to-many functionality, and the enhanced capability CXL switch 130 in the server 105 enables the many-to-one functionality. The server-linking switch 112 may be a PCIe switch, or a CXL switch, or both. In such a system, the requesters may be the processing circuits 115 of the multiple servers 105, the responders may be the many aggregated memory modules 135. The hierarchy of two switches (with the master switch being, as mentioned above, the server-linking switch 112, and the slave switch being the enhanced capability CXL switch 130) enables any-any communication. Each of the memory modules 135 may have one physical function (PF) and as many as 16 isolated logical devices. In some embodiments the number of logical devices (e.g., the number of partitions) may be limited (e.g. to 16), and one control partition (which may be a physical function used for controlling the device) may also be present. Each of the memory modules 135 may be a Type 2 device with CXL.cache, CXL.memory and CXL.io and address translation service (ATS) implementation to deal with cache line copies that the processing circuits 115 may hold. The enhanced capability CXL switch 130 and a fabric manager may control discovery of the memory modules 135 and (i) perform device discovery, and virtual CXL software creation, and (ii) bind virtual to physical ports. As in the embodiments of FIGS. 1A-1D, the fabric manager may operate through connections over an SMBus sideband. An interface to the memory modules 135, which may be Intelligent Platform Management Interface (IPMI) or an interface that complies with the Redfish standard (and that may also provide additional features not required by the standard), may enable configurability.

As mentioned above, some embodiments implement a hierarchical structure with a master controller (which may be implemented in an FPGA or in an ASIC) being part of the server-linking switch 112, and a slave controller being part of the enhanced capability CXL switch 130, to provide a load-store interface (i.e., an interface having cache-line (e.g., 64 byte) granularity and that operates within the coherence domain without software driver involvement). Such a load-store interface may extend the coherence domain beyond an individual server, or CPU or host, and may involve a physical medium that is either electrical or optical (e.g., an optical connection with electrical-to-optical transceivers at both ends). In operation, the master controller (in the server-linking switch 112) boots (or “reboots”) and configures all the servers 105 on the rack. The master controller may have visibility on all the hosts, and it may (i) discover each server and discover how many servers 105 and memory modules 135 exist in the server cluster, (ii) configure each of the servers 105 independently, (iii) enable or disable some blocks of memory (e.g., enable or disable any of the memory modules 135) on different servers, based on, e.g., the configuration of the racks, (iv) control access (e.g., which server can control which other server), (v) implement flow control (e.g. it may, since all host and device requests go through the master, transmit data from the one server to another server, and perform flow control on the data), (vi) group or batch requests or packets (e.g., multiple cache requests being received by the master from different servers 105), and (vii) receive remote software updates, broadcast communications, and the like. In batch mode, the server-linking switch 112 may receive a plurality of packets destined for the same server (e.g., destined for a first server) and send them together (i.e., without a pause between them) to the first server. For example, server-linking switch 112 may receive a first packet, from a second server, and a second packet, from a third server, and transmit the first packet and the second packet, together, to the first server. Each of the servers 105 may expose, to the master controller, (i) an IPMI network interface, (ii) a system event log (SEL), and (iii) a board management controller (BMC), enabling the master controller to measure performance, to measure reliability on the fly, and to reconfigure the servers 105.

In some embodiments, a software architecture that facilitates a high availability load-store interface is used. Such a software architecture may provide reliability, replication, consistency, system coherence, hashing, caching, and persistence. The software architecture may provide reliability (in a system with a large number of servers), by performing periodic hardware checks of the CXL device components via IPMI. For example, the server-linking switch 112 may query a status of a memory server 150, through an IPMI interface, of the memory server 150, querying, for example, the power status (whether the power supplies of the memory server 150 are operating properly), the network status (whether the interface to the server-linking switch 112 is operating properly) and an error check status (whether an error condition is present in any of the subsystems of the memory server 150). The software architecture may provide replication, in that the master controller may replicate data stored in the memory modules 135 and maintain data consistency across replicas.

The software architecture may provide consistency in that the master controller may be configured with different consistency levels, and the server-linking switch 112 may adjust the packet format according to the consistency level to be maintained. For example, if eventual consistency is being maintained, the server-linking switch 112 may reorder the requests, while to maintain strict consistency, the server-linking switch 112 may maintain a scoreboard of all requests with precise timestamps at the switches. The software architecture may provide system coherence in that multiple processing circuits 115 may be reading from or writing to the same memory address, and the master controller may, to maintain coherence, be responsible for reaching the home node of the address (using a directory lookup) or broadcasting the request on a common bus.

The software architecture may provide hashing in that the server-linking switch 112 and the enhanced capability CXL switch may maintain a virtual mapping of addresses which may use consistent hashing with multiple hash functions to evenly map data to all CXL devices across all nodes at boot-up (or to adjust when one server goes down or comes up). The software architecture may provide caching in that the master controller may designate certain memory partitions (e.g., in a memory module 135 that includes HBM or a technology with similar capabilities) to act as cache (employing write-through caching or write-back caching, for example). The software architecture may provide persistence in that the master controller and the slave controller may manage persistent domains and flushes.

In some embodiments, the capabilities of the CXL switch are integrated into the controller of a memory module 135. In such an embodiment, the server-linking switch 112 may nonetheless act as a master and have enhanced features as discussed elsewhere herein. The server-linking switch 112 may also manage other storage devices in the system, and it may have an Ethernet connection (e.g., a 100 GbE connection), for connecting, e.g., to client machines that are not part of the PCIe network formed by the server-linking switch 112.

In some embodiments, the server-linking switch 112 has enhanced capabilities and also includes an integrated CXL controller. In other embodiments, the server-linking switch 112 is only a physical routing device, and each server 105 includes a master CXL controller. In such an embodiment, masters across different servers may negotiate a master-slave architecture. The intelligence functions of (i) the enhanced capability CXL switch 130 and of (ii) the server-linking switch 112 may be implemented in one or more FPGAs, one or more ASICs, one or more ARM processors, or in one or more SSD devices with compute capabilities. The server-linking switch 112 may perform flow control, e.g., by reordering independent requests. In some embodiments, because the interface is load-store, RDMA is optional but there may be intervening RDMA requests that use the PCIe physical medium (instead of 100 GbE). In such an embodiment, a remote host may initiate an RDMA request, which may be transmitted to the enhanced capability CXL switch 130 through the server-linking switch 112. The server-linking switch 112 and the enhanced capability CXL switch 130 may prioritize RDMA 4 KB requests, or CXL's flit (64-byte) requests.

As in the embodiment of FIGS. 1C and 1D, the enhanced capability CXL switch 130 may be configured to receive such an RDMA request and it may treat a group of memory modules 135 in the receiving server 105 (i.e., the server receiving the RDMA request) as its own memory space. Further, the enhanced capability CXL switch 130 may virtualize across the processing circuits 115 and initiate RDMA request on remote enhanced capability CXL switches 130 to move data back and forth between servers 105, without the processing circuits 115 being involved.

FIG. 1F shows a system similar to that of FIG. 1E, in which the processing circuits 115 are connected to the network interface circuits 125 through the enhanced capability CXL switch 130. As in the embodiment of FIG. 1D, in FIG. 1F the enhanced capability CXL switch 130, the memory modules 135, and the network interface circuits 125 are on an expansion socket adapter 140. The expansion socket adapter 140 may be a circuit board or module that plugs into an expansion socket, e.g., a PCIe connector 145, on the motherboard of the server 105. As such, the server may be any suitable server, modified only by the installation of the expansion socket adapter 140 in the PCIe connector 145. The memory modules 135 may be installed in connectors (e.g., M.2 connectors) on the expansion socket adapter 140. In such an embodiment, (i) the network interface circuits 125 may be integrated into the enhanced capability CXL switch 130, or (ii) each network interface circuit 125 may have a PCIe interface (the network interface circuit 125 may be a PCIe endpoint), so that the processing circuit 115 to which it is connected may communicate with the network interface circuit 125 through a root port to endpoint PCIe connection, and the controller 137 of the enhanced capability CXL switch 130 (which may have a PCIe input port connected to the processing circuit 115 and to the network interface circuits 125) may communicate with the network interface circuit 125 through a peer-to-peer PCIe connection.

According to an embodiment of the present invention, there is provided a system, including: a first server, including: a stored-program processing circuit, a cache-coherent switch, and a first memory module; and a second server; and a server-linking switch connected to the first server and to the second server, wherein: the first memory module is connected to the cache-coherent switch, the cache-coherent switch is connected to the server-linking switch, and the stored-program processing circuit is connected to the cache-coherent switch. In some embodiments, the server-linking switch includes a Peripheral Component Interconnect Express (PCIe) switch. In some embodiments, the server-linking switch includes a Compute Express Link (CXL) switch. In some embodiments, the server-linking switch includes a top of rack (ToR) CXL switch. In some embodiments, the server-linking switch is configured to discover the first server. In some embodiments, the server-linking switch is configured to cause the first server to reboot. In some embodiments, the server-linking switch is configured to cause the cache-coherent switch to disable the first memory module. In some embodiments, the server-linking switch is configured to transmit data from the second server to the first server, and to perform flow control on the data. In some embodiments, the system further includes a third server connected to the server-linking switch, wherein: the server-linking switch is configured to: receive a first packet, from the second server, receive a second packet, from the third server, and transmit the first packet and the second packet to the first server. In some embodiments, the system further includes a second memory module connected to the cache-coherent switch, wherein the first memory module includes volatile memory and the second memory module includes persistent memory. In some embodiments, the cache-coherent switch is configured to virtualize the first memory module and the second memory module. In some embodiments, the first memory module includes flash memory, and the cache-coherent switch is configured to provide a flash translation layer for the flash memory. In some embodiments, the first server includes an expansion socket adapter, connected to an expansion socket of the first server, the expansion socket adapter including: the cache-coherent switch; and a memory module socket, the first memory module being connected to the cache-coherent switch through the memory module socket. In some embodiments, the memory module socket includes an M.2 socket. In some embodiments: the cache-coherent switch is connected to the server-linking switch through a connector, and the connector is on the expansion socket adapter. According to an embodiment of the present invention, there is provided a method for performing remote direct memory access in a computing system, the computing system including: a first server, a second server, a third server, and a server-linking switch connected to the first server, to the second server, and to the third server, the first server including: a stored-program processing circuit, a cache-coherent switch, and a first memory module, the method including: receiving, by the server-linking switch, a first packet, from the second server, receiving, by the server-linking switch, a second packet, from the third server, and transmitting the first packet and the second packet to the first server. In some embodiments, the method further includes: receiving, by the cache-coherent switch, a straight remote direct memory access (RDMA) request, and sending, by the cache-coherent switch, a straight RDMA response. In some embodiments, the receiving of the straight RDMA request includes receiving the straight RDMA request through the server-linking switch. In some embodiments, the method further includes: receiving, by the cache-coherent switch, a read command, from the stored-program processing circuit, for a first memory address, translating, by the cache-coherent switch, the first memory address to a second memory address, and retrieving, by the cache-coherent switch, data from the first memory module at the second memory address. According to an embodiment of the present invention, there is provided a system, including: a first server, including: a stored-program processing circuit, cache-coherent switching means, a first memory module; and a second server; and a server-linking switch connected to the first server and to the second server, wherein: the first memory module is connected to the cache-coherent switching means, the cache-coherent switching means is connected to the server-linking switch, and the stored-program processing circuit is connected to the cache-coherent switching means.

FIG. 1G shows an embodiment in which each of a plurality of memory servers 150 is connected to a ToR server-linking switch 112, which may be a PCIe 5.0 CXL switch, as illustrated. As in the embodiment of FIGS. 1E and 1F, the server-linking switch 112 may include an FPGA or ASIC, and may provide performance (in terms of throughput and latency) superior to that of an Ethernet switch. As in the embodiment of FIGS. 1E and 1F, the memory server 150 may include a plurality of memory modules 135 connected to the server-linking switch 112 through a plurality of PCIe connectors. In the embodiment of FIG. 1G, the processing circuits 115 and system memory 120 may be absent, and the primary purpose of the memory server 150 may be to provide memory, for use by other servers 105 having computing resources.

In the embodiment of FIG. 1G, the server-linking switch 112 may group or batch multiple cache requests received from different memory servers 150, and it may group packets, reducing control overhead. The enhanced capability CXL switch 130 may include composable hardware building blocks to (i) route data to different memory types based on workload, and (ii) virtualize processor-side addresses (translating such addresses to memory-side addresses). The system illustrated in FIG. 1G may be CXL 2.0 based, it may include composable and disaggregated shared memory within a rack, and it may use the ToR server-linking switch 112 to provide pooled (i.e., aggregated) memory to remote devices.

The ToR server-linking switch 112 may have an additional network connection (e.g., an Ethernet connection, as illustrated, or another kind of connection, e.g., a wireless connection such as a WiFi connection or a 5G connection) for making connections to other servers or to clients. The server-linking switch 112 and the enhanced capability CXL switch 130 may each include a controller, which may be or include a processing circuit such as an ARM processor. The PCIe interfaces may comply with the PCIe 5.0 standard or with an earlier version, or with a future version of the PCIe standard, or a different standard (e.g., NVDIMM-P, CCIX, or OpenCAPI) may be employed instead of PCIe. The memory modules 135 may include various memory types including DDR4 DRAM, HBM, LDPPR, NAND flash, and solid state drives (SSDs). The memory modules 135 may be partitioned or contain cache controllers to handle multiple memory types, and they may be in different form factors, such as HHHL, FHHL, M.2, U.2, mezzanine card, daughter card, E1.S, E1.L, E3.L, or E3.S.

In the embodiment of FIG. 1G, the enhanced capability CXL switch 130 may enable one-to-many and many-to-one switching, and it may enable a fine grain load-store interface at the flit (64-byte) level. Each memory server 150 may have aggregated memory devices, each device being partitioned into multiple logical devices each with a respective LD-ID. The enhanced capability CXL switch 130 may include a controller 137 (e.g., an ASIC or an FPGA), and a circuit (which may be separate from, or part of, such an ASIC or FPGA) for device discovery, enumeration, partitioning, and presenting physical address ranges. Each of the memory modules 135 may have one physical function (PF) and as many as 16 isolated logical devices. In some embodiments the number of logical devices (e.g., the number of partitions) may be limited (e.g. to 16), and one control partition (which may be a physical function used for controlling the device) may also be present. Each of the memory modules 135 may be a Type 2 device with CXL.cache, CXL.memory and CXL.io and address translation service (ATS) implementation to deal with cache line copies that the processing circuits 115 may hold.

The enhanced capability CXL switch 130 and a fabric manager may control discovery of the memory modules 135 and (i) perform device discovery, and virtual CXL software creation, and (ii) bind virtual to physical ports. As in the embodiments of FIGS. 1A-1D, the fabric manager may operate through connections over an SMBus sideband. An interface to the memory modules 135, which may be Intelligent Platform Management Interface (IPMI) or an interface that complies with the Redfish standard (and that may also provide additional features not required by the standard), may enable configurability.

Building blocks, for the embodiment of FIG. 1G, may include (as mentioned above) a CXL controller 137 implemented on an FPGA or on an ASIC, switching to enable aggregating of memory devices (e.g., of the memory modules 135), SSDs, accelerators (GPUs, NICs), CXL and PCIe5 connectors, and firmware to expose device details to the advanced configuration and power interface (ACPI) tables of the operating system, such as the heterogeneous memory attribute table (HMAT) or the static resource affinity table SRAT.

In some embodiments, the system provides composability. The system may provide an ability to online and offline CXL devices and other accelerators based on the software configuration, and it may be capable of grouping accelerator, memory, storage device resources and rationing them to each memory server 150 in the rack. The system may hide the physical address space and provide transparent cache using faster devices like HBM and SRAM.

In the embodiment of FIG. 1G, the controller 137 of the enhanced capability CXL switch 130 may (i) manage the memory modules 135, (ii) integrate and control heterogeneous devices such as NICs, SSDs, GPUs, DRAM, and (iii) effect dynamic reconfiguration of storage to memory devices by power-gating. For example, the ToR server-linking switch 112 may disable power (i.e., shut off power, or reduce power) to one of the memory modules 135 (by instructing the enhanced capability CXL switch 130 to disable power to the memory module 135). The enhanced capability CXL switch 130 may then disable power to the memory module 135, upon being instructed, by the server-linking switch 112, to disable power to the memory module. Such disabling may conserve power, and it may improve the performance (e.g., the throughput and latency) of other memory modules 135 in the memory server 150. Each remote server 105 may see a different logical view of memory modules 135 and their connections based on negotiation. The controller 137 of the enhanced capability CXL switch 130 may maintain state so that each remote server maintains allotted resources and connections, and it may perform compression or deduplication of memory to save memory capacity (using a configurable chunk size). The disaggregated rack of FIG. 1G may have its own BMC. It also may expose an IPMI network interface and a system event log (SEL) to remote devices, enabling the master (e.g., a remote server using storage provided by the memory servers 150) to measure performance and reliability on the fly, and to reconfigure the disaggregated rack. The disaggregated rack of FIG. 1G may provide reliability, replication, consistency, system coherence, hashing, caching, and persistence, in a manner analogous to that described herein for the embodiment of FIG. 1E, with, e.g., coherence being provided with multiple remote servers reading from or writing to the same memory address, and with each remote server being configured with different consistency levels. In some embodiments, the server-linking switch maintains eventual consistency between data stored on a first memory server, and data stored on a second memory server. The server-linking switch 112 may maintain different consistency levels for different pairs of servers; for example, the server-linking switch may also maintain, between data stored on the first memory server, and data stored on a third memory server, a consistency level that is strict consistency, sequential consistency, causal consistency, or processor consistency. The system may employ communications in “local-band” (the server-linking switch 112) and “global-band” (disaggregated server) domains. Writes may be flushed to the “global band” to be visible to new reads from other servers. The controller 137 of the enhanced capability CXL switch 130 may manage persistent domains and flushes separately for each remote server. For example, the cache-coherent switch may monitor a fullness of a first region of memory (volatile memory, operating as a cache), and, when the fullness level exceeds a threshold, the cache-coherent switch may move data from the first region of memory to a second region of memory, the second region of memory being in persistent memory. Flow control may be handled in that priorities may be established, by the controller 137 of the enhanced capability CXL switch 130, among remote servers, to present different perceived latencies and bandwidths.

According to an embodiment of the present invention, there is provided a system, including: a first memory server, including: a cache-coherent switch, and a first memory module; and a second memory server; and a server-linking switch connected to the first memory server and to the second memory server, wherein: the first memory module is connected to the cache-coherent switch, and the cache-coherent switch is connected to the server-linking switch. In some embodiments, the server-linking switch is configured to disable power to the first memory module. In some embodiments: the server-linking switch is configured to disable power to the first memory module by instructing the cache-coherent switch to disable power to the first memory module, and the cache-coherent switch is configured to disable power to the first memory module, upon being instructed, by the server-linking switch, to disable power to the first memory module. In some embodiments, the cache-coherent switch is configured to perform deduplication within the first memory module. In some embodiments, the cache-coherent switch is configured to compress data and to store compressed data in the first memory module. In some embodiments, the server-linking switch is configured to query a status of the first memory server. In some embodiments, the server-linking switch is configured to query a status of the first memory server through an Intelligent Platform Management Interface (IPMI). In some embodiments, the querying of a status includes querying a status selected from the group consisting of a power status, a network status, and an error check status. In some embodiments, the server-linking switch is configured to batch cache requests directed to the first memory server. In some embodiments, the system further includes a third memory server connected to the server-linking switch, wherein the server-linking switch is configured to maintain, between data stored on the first memory server and data stored on the third memory server, a consistency level selected from the group consisting of strict consistency, sequential consistency, causal consistency, and processor consistency. In some embodiments, the cache-coherent switch is configured to: monitor a fullness of a first region of memory, and move data from the first region of memory to a second region of memory, wherein: the first region of memory is in volatile memory, and the second region of memory is in persistent memory. In some embodiments, the server-linking switch includes a Peripheral Component Interconnect Express (PCIe) switch. In some embodiments, the server-linking switch includes a Compute Express Link (CXL) switch. In some embodiments, the server-linking switch includes a top of rack (ToR) CXL switch. In some embodiments, the server-linking switch is configured to transmit data from the second memory server to the first memory server, and to perform flow control on the data. In some embodiments, the system further includes a third memory server connected to the server-linking switch, wherein: the server-linking switch is configured to: receive a first packet, from the second memory server, receive a second packet, from the third memory server, and transmit the first packet and the second packet to the first memory server. According to an embodiment of the present invention, there is provided a method for performing remote direct memory access in a computing system, the computing system including: a first memory server; a first server; a second server; and a server-linking switch connected to the first memory server, to the first server, and to the second server, the first memory server including: a cache-coherent switch, and a first memory module; the first server including: a stored-program processing circuit; the second server including: a stored-program processing circuit; the method including: receiving, by the server-linking switch, a first packet, from the first server; receiving, by the server-linking switch, a second packet, from the second server; and transmitting the first packet and the second packet to the first memory server. In some embodiments, the method further includes: compressing data, by the cache-coherent switch, and storing the data in the first memory module. In some embodiments, the method further includes: querying, by the server-linking switch, a status of the first memory server. According to an embodiment of the present invention, there is provided a system, including: a first memory server, including: a cache-coherent switch, and a first memory module; and a second memory server; and server-linking switching means connected to the first memory server and to the second memory server, wherein: the first memory module is connected to the cache-coherent switch, and the cache-coherent switch is connected to the server-linking switching means.

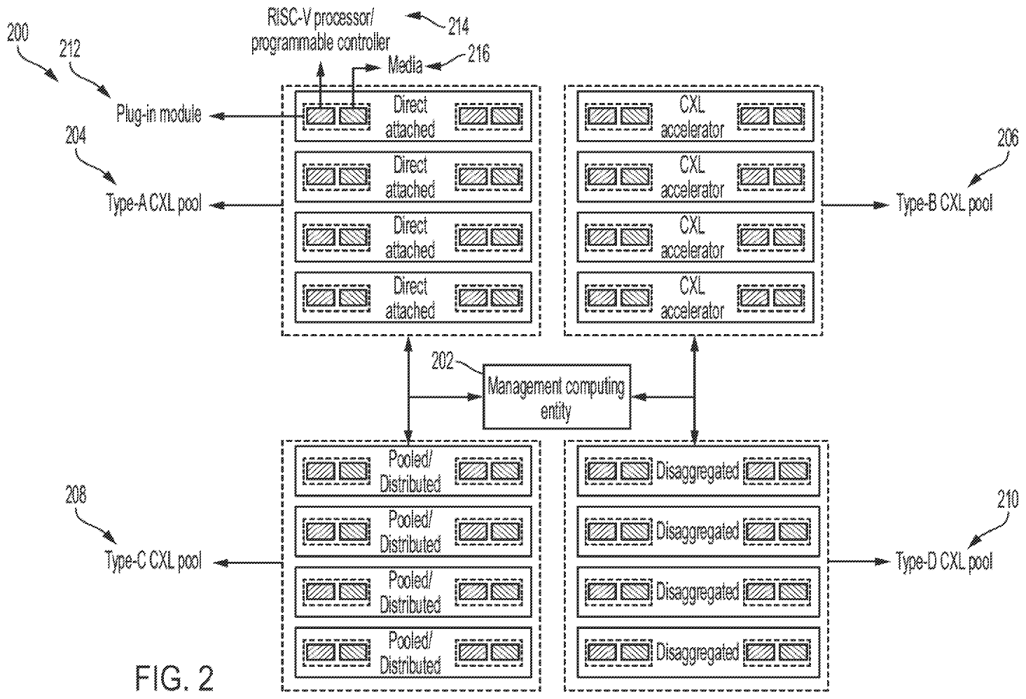

FIG. 2 depicts a diagram 200 of a representative system architecture in which aspects of the disclosed embodiments can operate in connection with a management computing entity that can communicate and configure the various servers described in connection with FIG. 1, in accordance with example embodiments of the disclosure. In some embodiments, the disclosed systems can include a management computing entity 202 that can be configured to operate in connection with multiple clusters. As shown, the clusters can include a type-A pool cluster 204, a type-B pool cluster 206, a type-C pool cluster 208, and a type-D pool cluster 210. In one embodiment, the type-A pool cluster 204 can include a direct-attached memory (e.g., CXL memory), the type-B pool cluster 206 can include an accelerator (e.g., CXL accelerator), the type-C pool cluster 208 can include a pooled/distributed memory (e.g., CXL memory), and a type-D pool cluster 210 can include a disaggregated memory (e.g., CXL memory). Further, each of the clusters can include, but not be limited to, a plug-in module 212 that can include a computing element 214 such as a processor (e.g., a RISC-V based processor) and/or a programmable controller (e.g., an FPGA-based controller), and corresponding media 216.

In various embodiments, the management computing entity 202 can be configured to direct I/O and memory storage and retrieval operations to the various clusters based on one or more predetermined parameters, for example, parameters associated with a corresponding workload being processed by a host or a device on the network in communication with the management computing entity 202.

In various embodiments, the management computing entity 202 can operate at a rack and/or cluster level, or may operate at least partially within a given device (e.g., cache-coherent enabled device) that is part of a given cluster architecture (e.g., type-A pool cluster 204, type-B pool cluster 206, type-C pool cluster 208, and type-D pool cluster 210). In various embodiments, the device within the given cluster architecture can perform a first portion of operations of the management computing entity while another portion of the operations of the management computing entity can be implemented on the rack and/or at the cluster level. In some embodiments, the two portions of operations can be performed in a coordinated manner (e.g., with the device in the cluster sending and receiving coordinating messages to and from the management computing entity implemented on the rack and/or at the cluster level). In some embodiments, the first portion of operations associated with the device in the cluster can include, but not be limited to, operations for determining a current or future resource need by the device or cluster, advertising a current or future resource availability by the device or cluster, synchronizing certain parameters associated with algorithms being run at the device or cluster level, training one or more machine learning modules associated with the device's or rack/cluster's operations, recording corresponding data associated with routing workloads, combinations thereof, and/or the like.

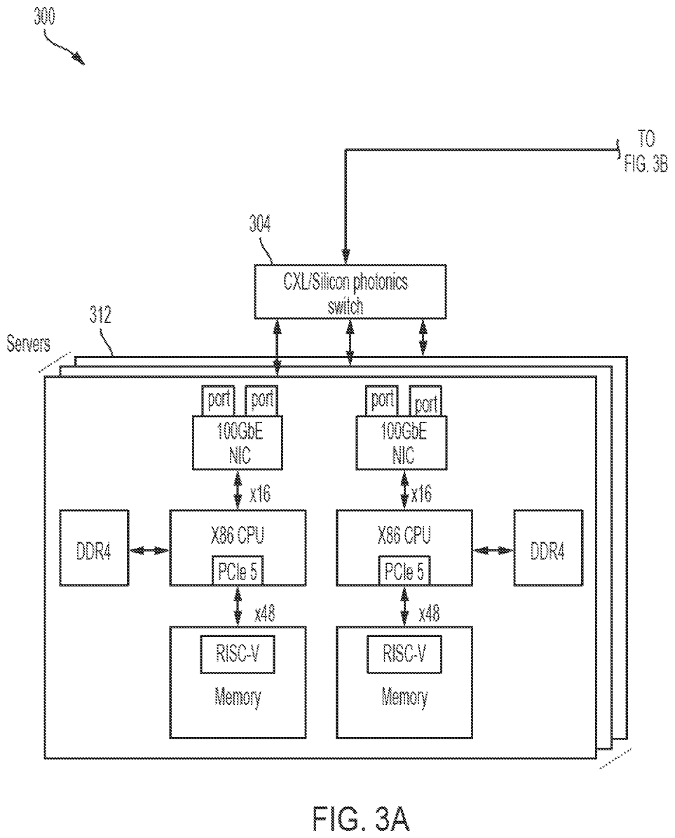

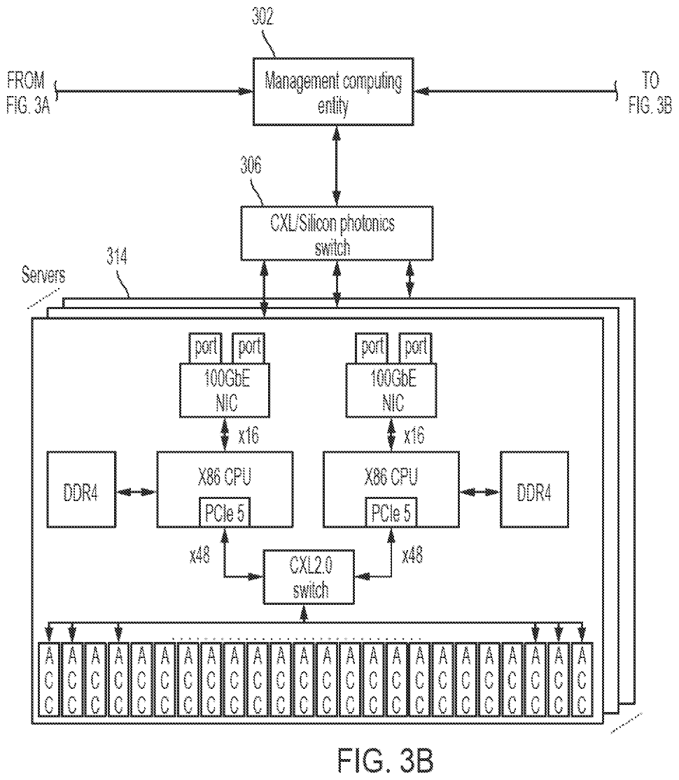

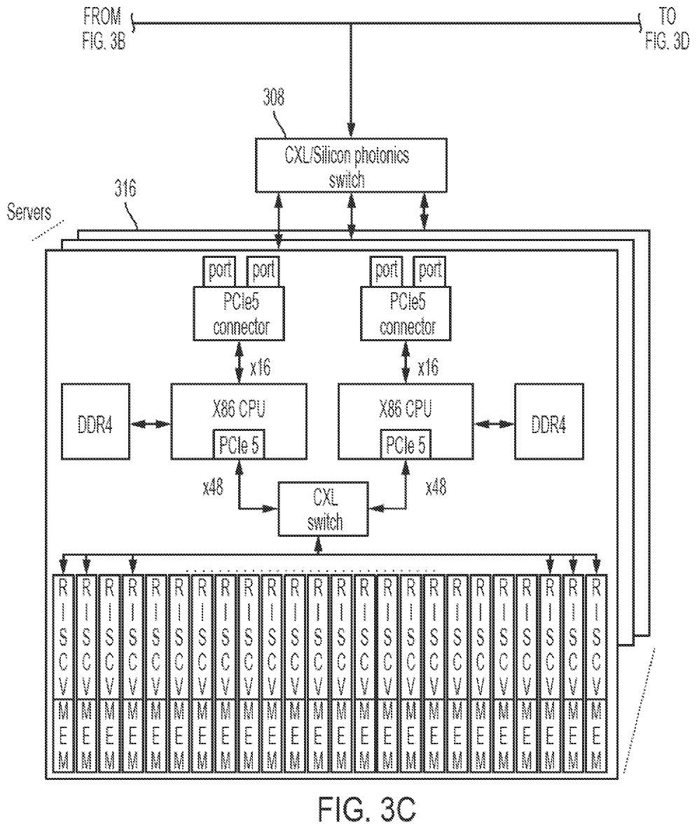

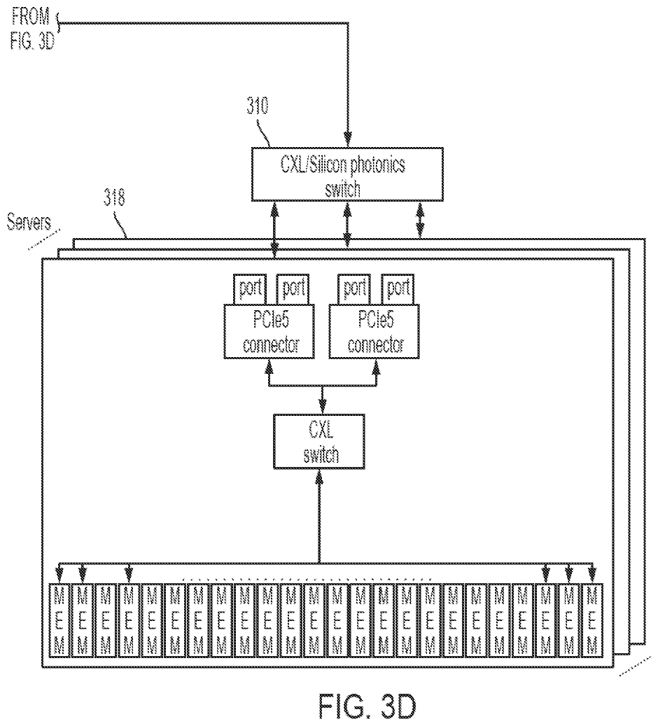

FIG. 3A depicts another diagram 300 of a representative system architecture in which aspects of the disclosed embodiments can operate in connection with a management computing entity that can communicate and configure the various servers described in connection with FIG. 1, in accordance with example embodiments of the disclosure. In some embodiments, the management computing entity 302 can be similar, but not necessarily identical to, the management computing entity 202 shown and described in connection with FIG. 2, above. Further, the management computing entity 202 can communicate with the type-A pool. In various embodiments, the type-A pool cluster 312 can include several servers. Moreover, the type-A pool cluster 312 can feature a direct-attached cache coherent (e.g., CXL) devices, which can, for example, be configured to operate using RCiEP. In another embodiment, type-A pool cluster 312 can feature a cache coherent protocol based memory such as CXL memory to reduce any limitations of CPU pins. In one embodiment, the type-A pool cluster 312 can include direct attached devices with a variety of form factor options (e.g., El, E3 form factors which can conform to an Enterprise & Data Center SSD Form Factor (EDSFF) standard and/or add-in card (AIC) form factor). In another embodiment, the disclosed systems can include a switch 304 such as a cache coherent (e.g., CXL) based switch and/or a silicon photonics based switch. In one embodiment, the switch 304 can feature a top of rack (ToR) Ethernet-based switch that can serve to scale the system to the rack level.

In various embodiments, as shown in FIG. 3B, the type-B pool cluster 314 can also include several servers. Moreover, the type-B pool cluster 314 can use a cache coherent based (e.g., a CXL 2.0 based) switch and accelerators, which can be pooled within a server of the servers. Moreover, the type-B pool cluster 314 can feature a virtual cache coherent protocol (e.g., CXL protocol) based switch (VCS) hierarchy capability based on workload. In particular, the VCS can be identified as a portion of the switch and connected components behind one specific root port (e.g., PCIe root port). In another embodiment, the disclosed systems can include a switch 306 such as a cache coherent (e.g., CXL) based switch and/or a silicon photonics based switch.

In various embodiments, as shown in FIG. 3C, the type-C pool cluster 316 can also include several servers. Moreover, the type-C pool cluster 316 can use a CXL 2.0 switch within a server of the servers. Additionally, the type-C pool cluster 316 can use a PCIe-based fabric and/or a Gen-Z based system to scale cache-coherent memory across the servers. Additionally, the type-C pool cluster 316 can introduce at least three pools of coherent memory in the cluster: a local DRAM, a local CXL memory, and a remote memory. In another embodiment, the disclosed systems can include a switch 308 such as a cache coherent (e.g., CXL) based switch and/or a silicon photonics based switch.

In various embodiments, as shown in FIG. 3D, the type-D pool cluster 318 can also include several servers. In one embodiment, the type-D pool cluster 318 can include a physically disaggregated CXL memory. Further, each server can be assigned a partition such that there may be limited or no sharing across servers. In some embodiments, the type-D pool cluster 318 may initially be limited to a predetermined number (e.g., 16) multiple logical device (MLD) partitions and hosts. In particular, type-3 cache coherent protocol (e.g., CXL) based memory devices can be partitioned to look like multiple devices with each device presenting a unique logical device ID. Additionally, the type-D pool cluster 318 can use a PCIe-based fabric and/or a Gen-Z based system to scale cache-coherent memory across the servers. In another embodiment, the disclosed systems can include a switch 310 such as a cache coherent (e.g., CXL) based switch and/or a silicon photonics based switch.

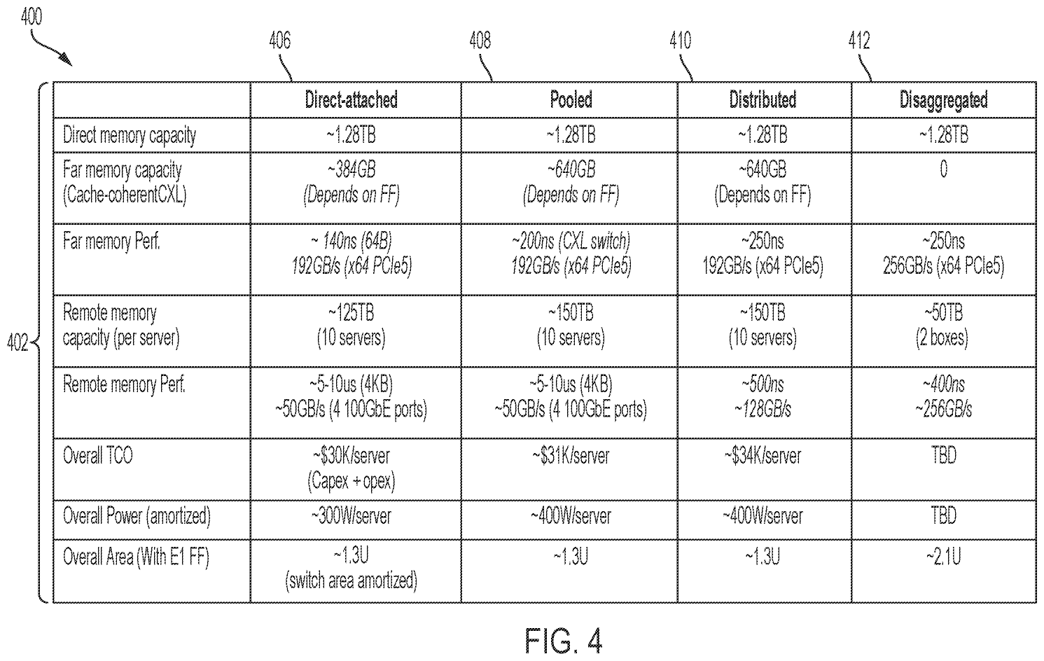

FIG. 4 depicts a diagram of a representative table of parameters that can characterize aspects of the servers described in connection with FIG. 1, where the management computing entity configure the various servers based on the table of parameters, in accordance with example embodiments of the disclosure. In particular, table 400 shows various example parameters that can be considered by the disclosed systems and in particular, by the management computing entity variously described herein, to route portions of workloads to different clusters based on a comparison of the values of these parameters (or similar parameters) for different pool cluster types described above. In particular, table 400 shows parameters 402 corresponding to different cluster types shown in the columns, namely, direct-attached 406 memory cluster (similar to a type-A pool cluster), a pooled 408 memory cluster (similar to a type-B pool cluster), a distributed 410 memory cluster (similar to a type-C pool cluster), and a disaggregated 412 memory cluster (similar to a type-D pool cluster). Non-limiting examples of such parameters 402 include direct-memory capacity, far memory capacity (e.g., for cache coherent protocols such as CXL), remote memory capacity (e.g., per server), remote memory performance, overall total cost of ownership (TCO), overall power (amortized), and overall area (e.g., with E1 form factors). In various embodiments, the disclosed systems can use a machine learning algorithm in association with the management computing entity to make a determination to route at least a portion of the workload to different clusters as further described below. While FIG. 4 shows some example parameters, the disclosed systems can be configured to monitor any suitable parameter to route workloads or portions of workloads to different devices associated with the clusters. Further, the management computing entity can perform such operations based on various parameters of the system including, but not limited to, a cache coherent protocol based (e.g., CXL based) round trip time, a determination of whether device is in host bias or device bias, a cache coherent protocol based (e.g., CXL based) switch hierarchy and/or a binding of host upstream ports to device downstream ports, a cache coherent protocol based (e.g., CXL based) switch fabric manager configuration, a cache coherent protocol based (e.g., CXL based) protocol packet or physical medium packet (e.g., a CXL.IO or PCIe intervening bulk 4 KB packet), a network latency, a cache coherent protocol based (e.g., CXL based) memory technology (e.g., type of memory), combinations thereof, and/or the like.

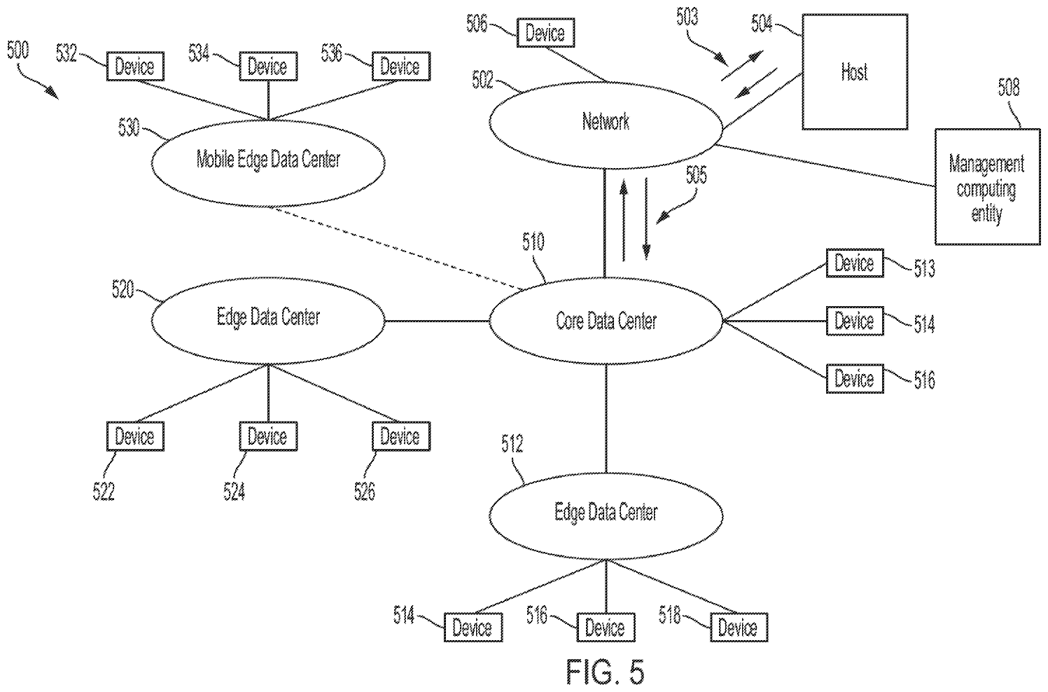

FIG. 5 depicts a diagram of a representative network architecture in which aspects of the disclosed embodiments can operate in connection with a first topology, in accordance with example embodiments of the disclosure. In particular, diagram 500 shows a network 502, a first data transmission 503, a host 504, a second data transmission 505, a device 506, a management computing entity 508, a core data center 510, devices 513, 514, and 516, edge data center 512, devices 514, 516, and 518, edge data center 520, devices 522, 524, and 526, mobile edge data center 530, and devices 532, 534, and 536, further described below. In various embodiments, the clusters (e.g., types A, B, C, and D pool clusters shown and described above), can part of one or more of the core data center 510, edge data center 512, edge data center 520, and/or mobile edge data center 530). Further, the devices (e.g., devices 506, 513, 514, 516, devices 522, 524, and 526, and devices 532, 534, and 536 can include devices (e.g., memory, accelerator, or similar devices) within or associated with a given cluster (e.g., any one of the type A, B, C, and D pool clusters shown and described above).

As used herein edge computing can refer to distributed computing systems which bring computation and data storage physically closer to the location where such resource may be needed, for example, to improve response times and save bandwidth. Edge computing can serve to move certain aspects of cloud computing, network control, and storage to network edge platforms (e.g., edge data centers and/or devices) that may be physically closer to resource-limited end devices, for example, to support computation-intensive and latency-critical applications. Accordingly, edge computing may lead to a reduction in latency and an increase in bandwidth on network architectures that incorporate both edge and core data centers. In some aspects, to provide low-latency services, an edge computing paradigm may optimize an edge computing platform design, aspects of which are described herein.

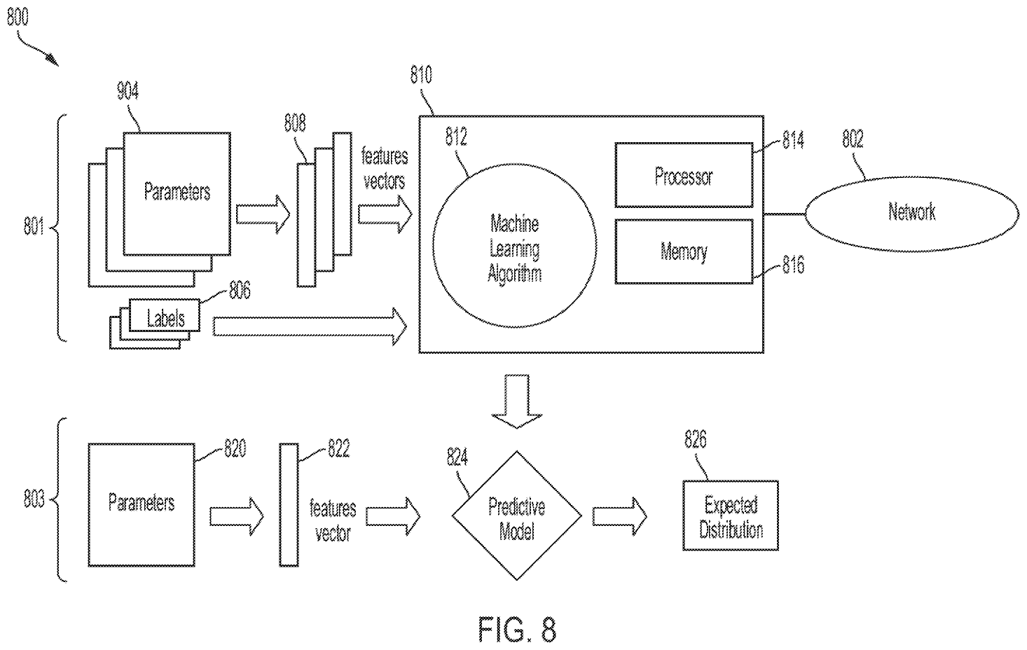

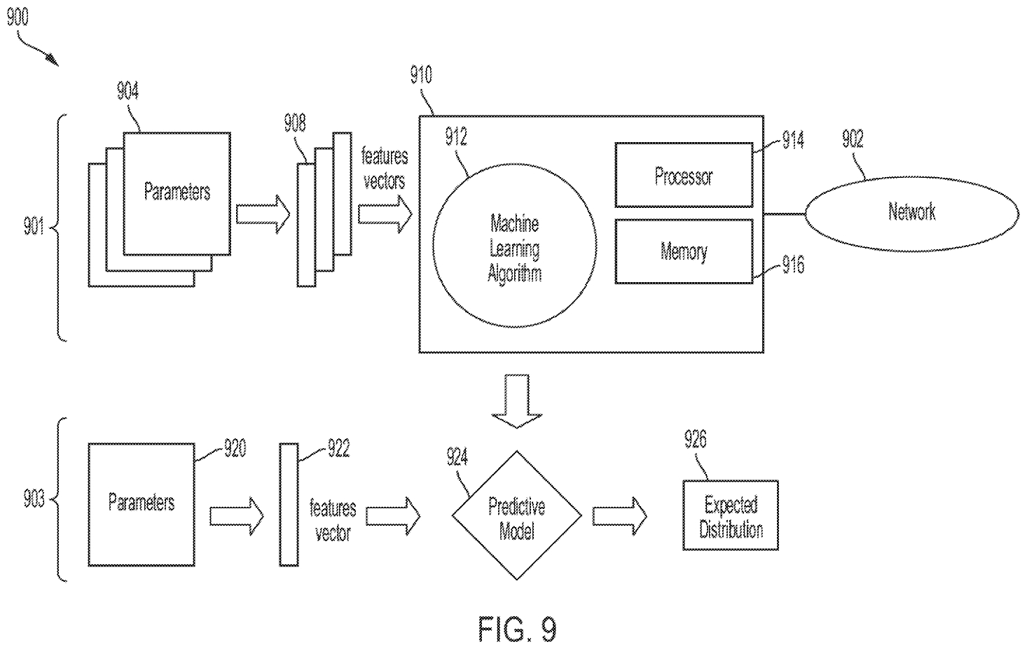

In some embodiments, diagram 500 shows that a host 504 can initiate a workload request via the first data transmission 503 to the network 502. The management computing entity 508 can monitor parameters (e.g., any suitable parameter such as those shown and described in connection with FIG. 4, above, in addition to data transmission rates, network portion utilizations, combinations thereof, and/or the like) associated with the network architecture (e.g., including, but not limited to, network parameters associated with the core data center 510 and various edge data centers such as edge data center 520 and edge data center 512 and/or any clusters of the same). Based on the results of the monitoring, the management computing entity 508 can determine to route at least a portion of the workload to one or more clusters of a core data center 510. In some examples, management computing entity 508 can further route a different portion of the workload to one or more clusters of an edge data center 512 or edge data center 520. In order to make the determination of where to route the workload, the management computing entity 508 can run a model of the network architecture and/or portions of the network (e.g., clusters associated with the edge data center, core data center, various devices, etc.) to determine parameters such as latencies and/or energy usages associated with different portions of the network architecture. As noted, the management computing entity 508 can use the parameters as inputs to a machine learning component (to be further shown and described in connection with FIGS. 8 and 9, below), to determine the optimal routing between one or more clusters of the core data center and edge data center for computation of the workload.

Now turning to the various components shown in diagram 500, a more detailed description of the various components will be provided below. In some embodiments, network 502 can include, but not be limited to, the Internet, or a public network such as a wide area network (WLAN). In some examples, host 504 can include a network host, for example, a computer or other device connected to a computer network. The host may operate as a server offering information resources, services, and applications to users or other hosts on the network 502. In some example, the host may be assigned at least one network address. In other examples, computers participating in a network such as the Internet can be referred to as Internet hosts. Such Internet hosts can include one or more IP addresses assigned to their respective network interfaces.

In some examples, device 506 can include a device that is directly connected to network 502, e.g., via a wired or wireless link. In some aspects, device 506 can initiate a workload (e.g., a video streaming request). The workload can then be processed by relevant portions of the network architecture in accordance with the disclosed embodiments herein. Examples of devices that can serve as device 506 are further shown and described in connection with FIG. 12, below.

In various embodiments, management computing entity 508 can perform routing of traffic and/or workload to one or more clusters of a core data center 510 and/or one or more clusters of one or more edge data centers 520. Further, management computing entity 508 can run a model/machine learning technique to determine parameters (e.g., latencies, energy usage, etc.) associated with one or more clusters of different portions of the network, for example, based on monitored network traffic data. As noted, in some embodiments, management computing entity 508 can run a machine learning model to determine how to route workload data. Examples of the machine learning model are shown and described in connection with FIGS. 8 and 9, below.

In some embodiments, the core data center 510 can include a dedicated entity that can house computer systems and associated components, such as telecommunications and storage systems and/or components. Further, the core data center 510 can include clusters (such as those shown and described in connection with FIGS. 1-2, above) having various servers that have computational, network, and storage resources for use in executing workloads, storing associated data, communicating data with the network 502, edge data centers (e.g., edge data center 520, mobile edge data center 530), and/or other portions (not shown) of the network architecture. In some embodiments, the core data center 510 can be connected to various devices (e.g., devices 513, 514, and 516). For example, the connection can be a wired connection (e.g., Ethernet-based) or a wireless connection (e.g., Wi-Fi, 5G, and/or cellular based). In another embodiment, the core data center 510 can receive workload requests from various devices (e.g., devices 513, 514, and 516) directly connected to the core data center 510, and can execute at least a portion of a given workload request (to be discussed further below). In some examples, the core data center 510 can transmit a result of a given workload to various devices that are either directly or indirectly connected to the core data center.

In some embodiments, the edge data center 512 can refer to a dedicated entity that can house computer systems and associated components, such as telecommunications and storage systems, and which can have many of the same or similar capabilities as core data centers; however, the edge data center 512 may generally have a smaller physical footprint in comparison to the core data center. Further, the edge data center 512, as noted, may be positioned physically closer to end users, and can thereby provide decreased latencies for certain workloads and applications. In some embodiments, the edge data center 512 can be connected to a core data center or other edge data centers (e.g., mobile edge data center 530 or edge data center 512). Moreover, one or more clusters of the edge data center 512 can receive workload requests from various devices (e.g., devices 522, 524, and 526) directly connected to the edge data center 512, and can execute at least a portion of a given workload request (to be discussed further herein). In another embodiment, the one or more clusters of the edge data center 512 can transmit a portion of a workload to other clusters of the edge data centers (e.g., edge data center 520) or core data center (e.g., core data center 510), for example, using a cache coherent protocol (e.g., CXL protocol). Further, the edge data center 512 can transmit a result of a given workload to various devices that are either directly or indirectly connected to the edge data center.

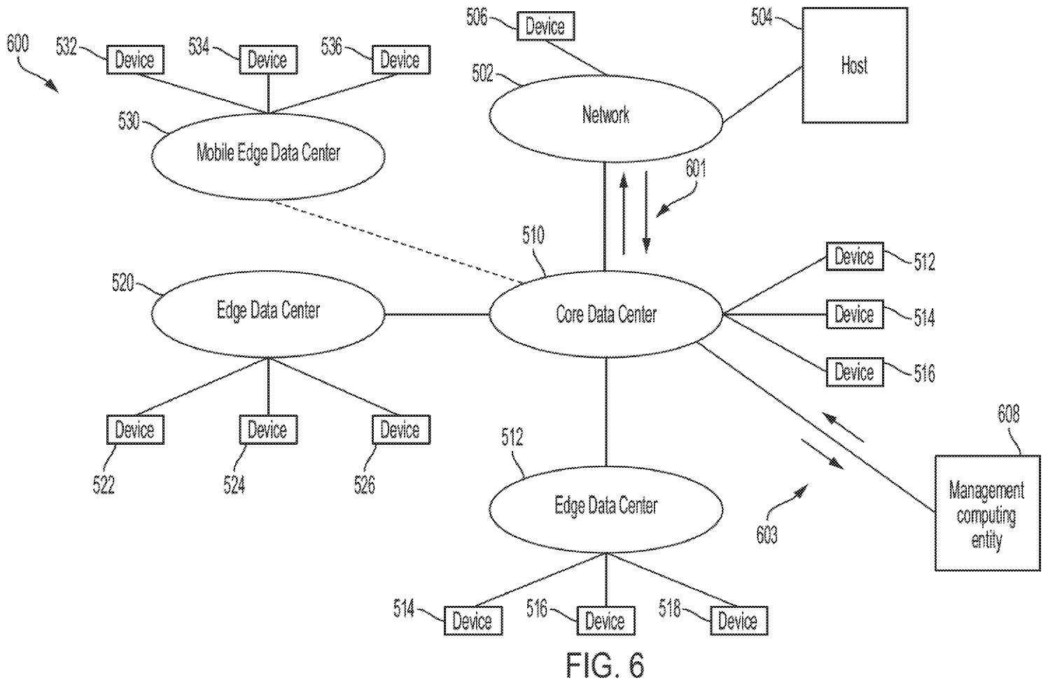

FIG. 6 depicts another diagram of the representative network architecture of FIG. 5 in which aspects of the disclosed embodiments can operate in connection with a second topology, in accordance with example embodiments of the disclosure. In particular, diagram 600 depicts many of the same elements as FIG. 5, described above. However, diagram 600 shows the management computing entity 608 which can be connected to the one or more clusters of core data center 510 in this second topology instead of the network 502 as in FIG. 5. This is meant to illustrate the possibility that the management computing entity can reside at different locations on the network architecture (e.g., one or more clusters of the core data center versus the network).

In some embodiments, diagram 600 further shows an example in which the network 502 can initiate a workload request via the first data transmission 601 to one or more clusters of the core data center 510. For example, a device (e.g., device 506) or a host (e.g., host 504) connected to the network 502 can generate the workload, which can be processed by the network 502 can initiate the workload request via the first data transmission 603. The management computing entity 608 can again monitor parameters (e.g., parameters shown and described in connection with FIG. 4 above in addition to data transmission rates, network portion utilizations, combinations thereof, and/or the like) associated with the network architecture (e.g., the network parameters including, but not limited to, network parameters associated with one or more clusters of the core data center 510 and various edge data centers such as edge data center 520 and edge data center 512).

Based on results of the monitoring, the management computing entity 608 can determine to maintain at least a portion of the workload to one or more clusters of a core data center 510. In some examples, management computing entity 608 can further route a different portion of the workload to one or more clusters of edge data center 512, edge data center 520, or even mobile edge data center 530 (e.g., an edge data center that can change locations, for example, via a wireless connection). As previously noted, to make the determination of where to route the workload, the management computing entity 608 can run a machine learning technique incorporating aspects of the network architecture and portions of the network to determine various parameters (e.g., latencies, energy usage, and/or the like) associated with different portions of the network architecture. The management computing entity 608 can use the parameters as inputs to a machine learning component (to be further shown and described in connection with FIGS. 8 and 9, below), to determine an optimal route between one or more clusters of the core data center and edge data center for computations of the workload.

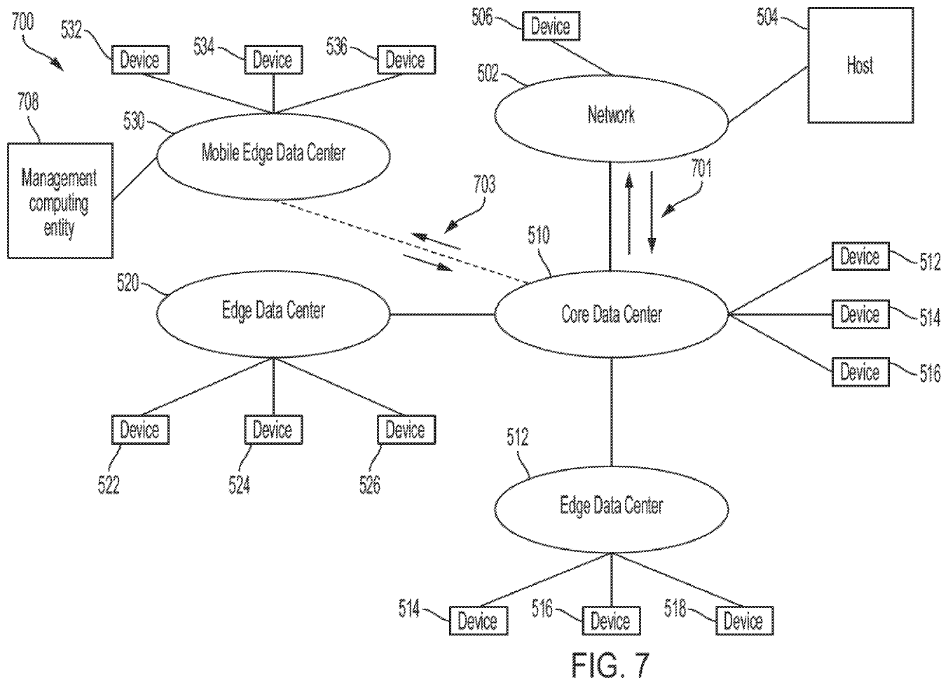

FIG. 7 depicts another diagram of the representative network architecture of FIG. 5 in which aspects of the disclosed embodiments can operate in connection with a third topology, in accordance with example embodiments of the disclosure. In particular, diagram 700 depicts many of the same elements as FIG. 5, described above. However, diagram 700 shows the management computing entity 708 which can be connected to one or more clusters of an example edge data center such as mobile edge data center 530 in this third topology instead of one or more clusters of the network 502 as in FIG. 5 or one or more clusters of the core data center 510 as in FIG. 6. Once again, this topology reflects the possibility that the management computing entity can reside at different locations on the network architecture (e.g., one or more clusters of an edge data center versus one or more clusters of the core data center and/or the network).

In some embodiments, diagram 700 further shows that the network 502 can initiate a workload request via the first data transmission 701 to one or more clusters of the core data center 510 and/or a second data transmission 703 to a mobile edge data center 530. For example, a device (e.g., device 506) or a host (e.g., host 504) connected to one or more clusters of the network 502 can generate the workload, which can be processed by one or more clusters of the network 502 and initiate the workload request via the data transmission 701. The management computing entity 708 can again monitor parameters (e.g., parameters shown and described in connection with FIG. 4, cache coherent protocol related parameters, and/or data transmission rates, network portion utilizations, combinations thereof, and/or the like) associated with the network architecture (e.g., including, but not limited to, parameters associated with one or more clusters of the core data center 510 and one or more clusters of various edge data centers such as mobile edge data center 530, edge data center 520, and/or edge data center 512).

Based on the results of the monitoring and/or determination of parameters and associated thresholds, the management computing entity 708 can determine to maintain at least a portion of the workload at one or more clusters of the mobile edge data center 530. In some examples, management computing entity 708 can further route a different portion of the workload to one or more clusters of the core data center 510, edge data center 512, and/or edge data center 520. As previously noted, to make the determination of where to route the workload, the management computing entity 708 can use the parameters as inputs to a machine learning component (to be further shown and described in connection with FIGS. 8 and 9, below), to determine the optimal routing between core data center and edge data center computation of the workload.

FIG. 8 depicts a diagram of a supervised machine learning approach for determining distributions of workloads across one or more clusters of different portions of a network architecture, in accordance with example embodiments of the disclosure. In particular, diagram 800 shows a supervised machine learning approach to determining a distribution of a given workload to one or more clusters of a core data center and one or more edge data center based on the parameters. More specifically, diagram 800 shows a training component 801 of the machine learning approach, the training component 801 including a network 802, parameters 804, labels 806, feature vectors 808, management computing entity 810, machine learning component 812, processor 814, and memory 816, to be described below. Further diagram 800 shows an inference component 803 of the machine learning approach, the inference component 803 including parameters 820, feature vector 822, predictive model 824, and expected distribution 826, also to be described below.

Now turning to the various components shown in diagram 800, a more detailed description is described. In particular, network 802 can be similar to network 502, shown and described in connection with FIG. 5, above. In some examples, the network 802 can be communicatively coupled to the management computing entity 810. In some embodiments, parameters 804 can include parameters shown and described in connection with FIG. 4 above and/or raw data transmitted on various portions of a network architecture between various entities such as those shown and described in connection with FIG. 5. In some examples, the raw data can include, but not be limited to, workloads, data transmissions, latencies, and/or data transmission rates on portions of the network. As noted, the disclosed systems can be configured to monitor any suitable parameter to route workloads or portions of workloads to different devices associated with the clusters. Further, the management computing entity can perform such operations based on various parameters of the system including, but not limited to, a cache coherent protocol based (e.g., CXL based) round trip time, a determination of whether device is in host bias or device bias, a cache coherent protocol based (e.g., CXL based) switch hierarchy and/or a binding of host upstream ports to device downstream ports, a cache coherent protocol based (e.g., CXL based) switch fabric manager configuration, a cache coherent protocol based (e.g., CXL based) protocol packet or physical medium packet (e.g., a CXL.IO or PCIe intervening bulk 4KB packet), a network latency, a cache coherent protocol based (e.g., CXL based) memory technology (e.g., type of memory), combinations thereof, and/or the like.

In some embodiments, labels 806 can represent optimal distributions of a given workload across one or more clusters of a core data center and one or more edge data centers in an example network architecture having a particular configuration. In some embodiments, the labels 806 can be determined using the results of a model. In various aspects, labels 806 can thereby be used to train a machine learning component 812, for example, to predict an expected distribution 826 of a given future workload across one or more clusters of a core data center and one or more edge data centers during the inference component 803.

In some embodiments, feature vectors 808 can represent various parameters of interest (e.g., parameters shown and described in connection with FIG. 4, latencies, and/or data transmission rates, combinations thereof, and/or the like) that can, in some examples, be extracted from the raw data and/or that may be part of the parameters 804. In some examples, the feature vectors 808 can represent individual measurable properties or characteristics of the transmissions observed by the management computing entity over the network architecture.

In other embodiments, management computing entity 810 can be communicatively coupled to the network 802, and can include a machine learning component 812, a processor 814, and memory 816. In particular, the machine learning component 812 can use any suitable machine learning technique to generate a predictive model 824 of an expected distribution 826 for processing a given workload across one or more clusters of a core data center and one or more edge data centers. Non-limiting machine learning techniques can include, but not be limited to, a supervised learning technique (shown and described in connection with FIG. 8), an unsupervised learning technique (shown and described in connection with FIG. 9), a reinforcement learning technique, a self-learning technique, a feature learning technique, an association rules technique, combinations thereof, and/or the like. Additional non-limiting machine learning techniques can include, but not be limited to, specific implementations such as artificial neural networks, decision trees, support vector machines, regression analysis techniques, Bayesian network techniques, genetic algorithm techniques, combinations thereof, and/or the like.

As noted, diagram 800 includes an inference component 803. In particular, the inference component 803 may be similar to the training component 801 in that parameters 820 are received, feature vectors are extracted (e.g., by the management computing entity 810), and a machine learning component 812 executing a predictive model 824 is used to determine an expected distribution 826 of processing of a given workload across one or more clusters of a core data center and one or more edge data centers. One difference between the inference component 803 and the training component 801 is that the inference component may not receive labels (e.g., labels 806) to train the machine learning component to determine the distribution. Accordingly, in the inference component 803 mode of operation, the management computing entity 810 can determine the expected distribution 826 of the given workload live. Subsequently, if an error rate (defined, for example, based on the overall latency reduction for a given workload) is below a predetermined threshold, the machine learning component 812 can be retrained using the training component 801 (e.g., with different label 806 associated with different or similar network parameters 804). The inference component 803 can be subsequently run to improve the error rate to be above the predetermined threshold.

FIG. 9 depicts a diagram of an unsupervised machine learning approach for determining distributions of workloads across different portions of a network architecture, in accordance with example embodiments of the disclosure. In particular, diagram 900 shows a network 902 connected to the management computing entity 910. Further, diagram 900 includes a training component 901 of the machine learning approach, including parameters 904, feature vectors 908, a management computing entity 910 having a machine learning component 912, processor 914, and memory 916. Moreover, diagram 900 includes a training component 903 of the machine learning approach, including parameters 920, feature vector(s) 922, a model 924, and an expected distribution 926 of a workload across one or more clusters of core and edge data centers.

Now turning to the various components shown in diagram 900, a more detailed description is provided. In particular, network 902 can be similar to network 502, shown and described in connection with FIG. 5, above. In some examples, the network 902 can be communicatively coupled to the management computing entity 910. In some embodiments, network parameters 904 can include raw data that is transmitted on various portions of a network architecture such as that shown and described in connection with FIG. 5. In some examples, the raw data can include, but not be limited to, workloads, data transmissions, latencies, and/or data transmission rates on portions of the network, combinations thereof, and/or the like.

In some embodiments, in contrast to the labels 806 representing optimal distributions of a given workload across one or more clusters of a core data center and one or more edge data centers shown and described in connection with FIG. 8, above, training component 901 may not have such labels. Rather, the management computing entity 910 can the train the machine learning component 912 (for example, to predict an expected distribution 926 of a given future workload across one or more clusters of a core data center and one or more edge data centers using the inference component 903) without any labels.

In some embodiments, feature vectors 908 can represent various parameters of interest (e.g., latencies, and/or data transmission rates) that can be extracted from the raw data that may be part of the parameters 904. In some examples, the feature vectors 908 can represent individual measurable properties or characteristics of the transmissions observed by the management computing entity over the network architecture.

In other embodiments, management computing entity 910 can be communicatively coupled to the network 902, and can include a machine learning component 912, a processor 914, and memory 916. In particular, the machine learning component 912 can use any suitable machine learning technique to generate a model 924 of an expected distribution 926 of processing a given workload across one or more clusters of a core data center and one or more edge data centers.

As noted, diagram 900 includes an inference component 903. In particular, the inference component 903 may be similar to the training component 901 in that parameters 920 are received, feature vectors 922 are extracted (e.g., by the management computing entity 910), and a machine learning component 910 executing a model 924 is used to determine an expected distribution 926 of processing of a given workload across one or more clusters of a core data center and one or more edge data centers. Accordingly, in the inference component 903 mode of operation, the management computing entity 910 can determine the expected distribution 926 of the given workload live. Subsequently, if an error rate (defined, for example, based on the overall latency reduction for a given workload) is below a predetermined threshold, the machine learning component 912 can be retrained using the training component 901. The inference component 903 can be subsequently run to improve the error rate to be above the predetermined threshold.

In addition and/or in combination with the various parameters described above, the disclosed systems can additionally consider parameters to consider for dynamically routing I/O from one cluster to another using machine learning and/or any other suitable AI-based technique can include, but not be limited to, an energy cost/usage per cluster/rack/server/device, a peak load per cluster/rack/server/device in a given time interval, a heat efficiency (e.g., in cycles per British Thermal Units (BTUs) of heat produced) per cluster/rack/server/device, a type of processor (e.g., x86 based process) available and the number of processors available in a given cluster/rack/server/device, and a degree of symmetry from a cache coherent point of view. Further, the disclosed systems can consider a cluster's constituent memory resources, for example, a type of memory technology (e.g., DRAM, Triple-level cells (TLC), quad-level cells (QLC), etc.) that can be per cluster/rack/server/device.

In various embodiments, the disclosed systems can determine additional criteria for routing a given workload to one or more clusters. For example, the disclosed systems can determine one or more of a data rate, a material basis of a network connection, and signal loss budget to determine the maximum distance signals can be transported on a given network (e.g., a PCIe Gen-5-based network) for a given bit error rate associated with data transmission.

As another example, the disclosed systems can determine whether retimers are needed (number and location) and what the added latency will be using the retimers to determine total latency addition.

In various embodiments, the disclosed systems can determine, for asymmetric data flow with asymmetric coherence, what data path to use for which cluster/rack/server/device. Moreover, the disclosed systems can determine a breakdown for a given workload and associated expected latencies for each sub-function, then route data to accelerate the most critical pieces using CXL to the lowest latency accelerators. For example, for object detection workloads, the disclosed systems can route data based on the above technique for the image segmentation phase rather than for the object database retrieval phase or vice versa.

As noted, in some aspects, the management computing unit 910 may use artificial intelligence (AI) (e.g., the machine learning components shown and described above in connection with FIGS. 8 and 9) to determine the routing of workloads between the portions of a network architecture, for example, by monitoring data flow over different portions of the network over time (e.g., historical data) for enhanced workload routing. Accordingly, embodiments of devices, management computing entity, and/or related components described herein can employ AI to facilitate automating one or more features described herein. The components can employ various AI-based schemes for carrying out various embodiments/examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations. In some aspects, the neural network can include, but not be limited to, at least one of a long short term memory (LSTM) neural network, a recurrent neural network, a time delay neural network, or a feed forward neural network.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

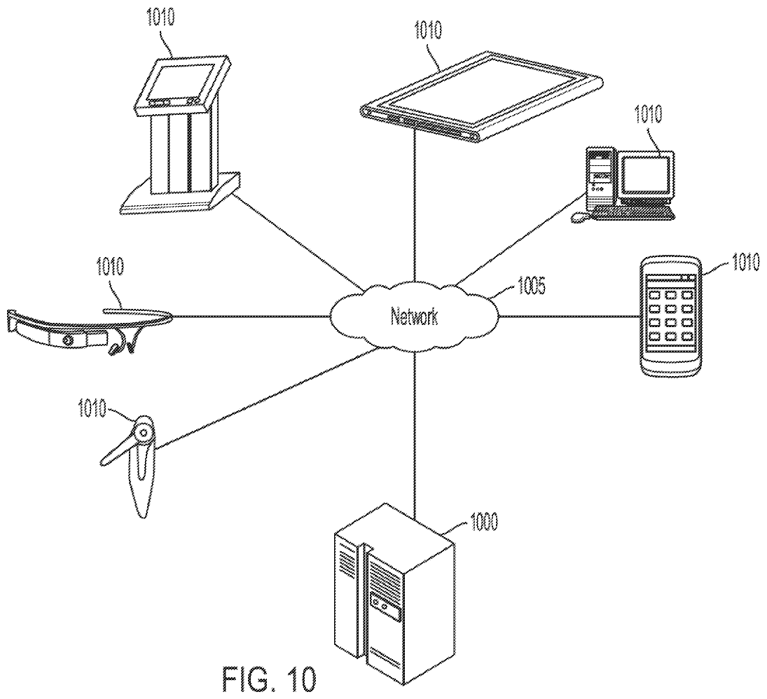

FIG. 10 shows an example schematic diagram of a system that can be used to practice embodiments of the present disclosure. As shown in FIG. 10, this particular embodiment may include one or more management computing entities 1000, one or more networks 1005, and one or more user devices 1010. Each of these components, entities, devices, systems, and similar words used herein interchangeably may be in direct or indirect communication with, for example, one another over the same or different wired or wireless networks (e.g., network 502 shown and described in connection with FIG. 5 including, but not limited to, edge data centers and/or core data centers and associated clusters). Additionally, while FIG. 10 illustrates the various system entities as separate, standalone entities, the various embodiments are not limited to this particular architecture. Further, the management computing entities 1000 can include the machine learning components described herein. As noted, the communications can be performed using the any suitable protocols (e.g., a 5G network protocol, a cache coherent protocol), described further herein.

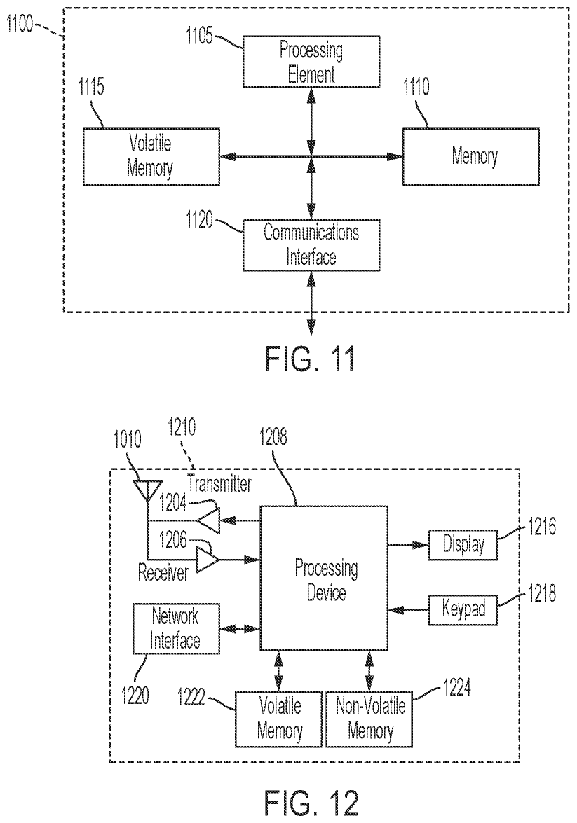

FIG. 11 shows an example schematic diagram of a management computing entity, in accordance with example embodiments of the disclosure. Further, the management computing entity 1100 may include a content component, a processing component, and a transmitting component (not shown). In particular, the content component may serve to determine signals indicative of data (e.g., video, audio, text, data, combinations thereof, and/or the like) to be transmitted over the network architecture described herein. In another embodiment, the determination of the signal for transmission may be, for example, based on a user input to the device, a predetermined schedule of data transmissions on the network, changes in network conditions, and the like. In one embodiment, the signal may include that data may be encapsulated in a data frame (e.g., a 5G data frame and/or a cache coherent protocol data frame) that is configured to be sent from a device to one or more devices on the network.

In another embodiment, the processing element 1105 may serve to determine various parameters associated data transmitted over the network (e.g., network 1005 shown and described in connection with FIG. 10, above) and/or parameters associated with the clusters of the portions of the network. For example, the processing element 1105 may serve to run a model on the network data, run a machine learning technique on the network data, determine distributions of workloads to be processed by various portions of the network architecture, combinations thereof, and/or the like. As another example. the processing element 1105 may serve to run a model on the network data, run a machine learning technique on parameters associated with different performance capabilities of the clusters of the network, determine distributions of workloads to be processed by various clusters of the portions of the network architecture, combinations thereof, and/or the like.

In one embodiment, a transmitting component (not shown) may serve to transmit the signal from one device to another device on the network (e.g., from a first device on a first cluster to a second device on a second cluster, for example, using a cache coherent protocol). For example, the transmitting component may serve to prepare a transmitter (e.g., transmitter 1204 of FIG. 12, below) to transmit the signal over the network. For example, the transmitting component may queue data in one or more buffers, may ascertain that the transmitting device and associated transmitters are functional and have adequate power to transmit the signal over the network, may adjust one or more parameters (e.g., modulation type, signal amplification, signal power level, noise rejection, combinations thereof, and/or the like) associated with the transmission of the data.

In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (for example Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the management computing entity 1000 may also include one or more communications interfaces 1120 for communicating with various computing entities, such as by communicating data, content, information, and/or similar terms used herein interchangeably that can be transmitted, received, operated on, processed, displayed, stored, and/or the like. For instance, the management computing entity 1000 may communicate with user devices 1010 and/or a variety of other computing entities.

As shown in FIG. 11, in one embodiment, the management computing entity 1000 may include or be in communication with one or more processing elements 1105 (also referred to as processors, processing circuitry, and/or similar terms used herein interchangeably) that communicate with other elements within the management computing entity 1000 via a bus, for example. As will be understood, the processing element 1105 may be embodied in a number of different ways. For example, the processing element 1105 may be embodied as one or more complex programmable logic devices (CPLDs), microprocessors, multi-core processors, coprocessing entities, application-specific instruction-set processors (ASIPs), microcontrollers, and/or controllers. Further, the processing element 1105 may be embodied as one or more other processing devices or circuitry. The term circuitry may refer to an entirely hardware embodiment or a combination of hardware and computer program products. Thus, the processing element 1105 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 1105 may be configured for a particular use or configured to execute instructions stored in volatile or non-volatile media or otherwise accessible to the processing element 1105. As such, whether configured by hardware or computer program products, or by a combination thereof, the processing element 1105 may be capable of performing steps or operations according to embodiments of the present disclosure when configured accordingly.

In one embodiment, the management computing entity 1000 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 1110, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program components, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 1000 may further include or be in communication with volatile media (also referred to as volatile storage, memory, memory storage, memory circuitry and/or similar terms used herein interchangeably). In one embodiment, the volatile storage or memory may also include one or more volatile storage or memory media 1115, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program components, scripts, source code, object code, byte code, compiled code, interpreted code, machine code, executable instructions, and/or the like being executed by, for example, the processing element 1105. Thus, the databases, database instances, database management systems, data, applications, programs, program components, scripts, source code, object code, byte code, compiled code, interpreted code, machine code, executable instructions, and/or the like may be used to control certain aspects of the operation of the management computing entity 1000 with the assistance of the processing element 1105 and operating system.

As indicated, in one embodiment, the management computing entity 1000 may also include one or more communications interfaces 1120 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as peripheral component interconnect express (PCIe), fiber distributed data interface (FDDI), digital subscriber line (DSL), Ethernet, asynchronous transfer mode (ATM), frame relay, data over cable service interface specification (DOC SIS), or any other wired transmission protocol. Similarly, the management computing entity 1000 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, ZigBee, Bluetooth protocols, 5G protocol, wireless universal serial bus (USB) protocols, and/or any other wireless protocol.

Although not shown, the management computing entity 1000 may include or be in communication with one or more input elements, such as a keyboard input, a mouse input, a touch screen/display input, motion input, movement input, audio input, pointing device input, joystick input, keypad input, and/or the like. The management computing entity 1000 may also include or be in communication with one or more output elements (not shown), such as audio output, video output, screen/display output, motion output, movement output, and/or the like.

As will be appreciated, one or more of the management computing entity's 1000 components may be located remotely from other management computing entity 1000 components, such as in a distributed system. Furthermore, one or more of the components may be combined and additional components performing functions described herein may be included in the management computing entity 1000. Thus, the management computing entity 1000 can be adapted to accommodate a variety of needs and circumstances. As will be recognized, these architectures and descriptions are provided for example purposes only and are not limiting to the various embodiments.

A user may be an individual, a family, a company, an organization, an entity, a department within an organization, a representative of an organization and/or person, and/or the like. In one example, users may be employees, residents, customers, and/or the like. For instance, a user may operate a user device 1010 that includes one or more components that are functionally similar to those of the management computing entity 1000.

In various aspects, the processing component, the transmitting component, and/or the receiving component (not shown) may be configured to operate on one or more may include aspects of the functionality of the management computing entity 1000, as shown and described in connection with FIGS. 10 and 11 here. In particular, the processing component, the transmitting component, and/or the receiving component may be configured to be in communication with one or more processing elements 1105, memory 1110, volatile memory 1115, and may include a communication interface 1120 (e.g., to facilitate communication between devices).

FIG. 12 shows an example schematic diagram of a user device, in accordance with example embodiments of the disclosure. FIG. 12 provides an illustrative schematic representative of a user device 1010 (shown in connection with FIG. 10) that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (for example Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User devices 1010 can be operated by various parties. As shown in FIG. 12, the user device 1010 can include an antenna 1212, a transmitter 1204 (for example radio), a receiver 1206 (for example radio), and a processing element 1208 (for example CPLDs, FPGAs, microprocessors, multi-core processors, coprocessing entities, ASIPs, microcontrollers, and/or controllers) that provides signals to and receives signals from the transmitter 1204 and receiver 1206, respectively.

The signals provided to and received from the transmitter 1204 and the receiver 1206, respectively, may include signaling information in accordance with air interface standards of applicable wireless systems. In this regard, the user device 1010 may be capable of operating with one or more air interface standards, communication protocols, modulation types, and access types. More particularly, the user device 1010 may operate in accordance with any of a number of wireless communication standards and protocols, such as those described above with regard to the management computing entity 1000 of FIG. 10. In a particular embodiment, the user device 1010 may operate in accordance with multiple wireless communication standards and protocols, such as the disclosed IoT DOCSIS protocol, UMTS, CDMA2000, 1×RTT, WCDMA, TD-SCDMA, LTE, E-UTRAN, EVDO, HSPA, HSDPA, 5G, Wi-Fi, Wi-Fi Direct, WiMAX, UWB, IR, NFC, Bluetooth, USB, and/or the like. Similarly, the user device 1010 may operate in accordance with multiple wired communication standards and protocols, such as those described above with regard to the management computing entity 1000 via a network interface 1220.

Via these communication standards and protocols, the user device 1010 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Component Dialer (SIM dialer). The user device 1010 can also download changes, add-ons, and updates, for instance, to its firmware, software (for example including executable instructions, applications, program components), and operating system.

According to one embodiment, the user device 1010 may include location determining aspects, devices, components, functionalities, and/or similar words used herein interchangeably. The location determining aspects may be used to inform the models used by the management computing entity and one or more of the models and/or machine learning techniques described herein. For example, the user device 1010 may include outdoor positioning aspects, such as a location component adapted to acquire, for example, latitude, longitude, altitude, geocode, course, direction, heading, speed, universal time (UTC), date, and/or various other information/data. In one embodiment, the location component can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user device's 1010 position in connection with a variety of other systems, including cellular towers, Wi-Fi access points, and/or the like. Similarly, the user device 1010 may include indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (for example smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user device 1010 may also comprise a user interface (that can include a display 1216 coupled to a processing element 1208) and/or a user input interface (coupled to a processing element 1208). For example, the user interface may be a user application, browser, user interface, and/or similar words used herein interchangeably executing on and/or accessible via the user device 1010 to interact with and/or cause display of information from the management computing entity 1000, as described herein. The user input interface can comprise any of a number of devices or interfaces allowing the user device 1010 to receive data, such as a keypad 1218 (hard or soft), a touch display, voice/speech or motion interfaces, or other input devices. In embodiments including a keypad 1218, the keypad 1218 can include (or cause display of) the conventional numeric (0-9) and related keys (#, *), and other keys used for operating the user device 1010 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user device 1010 can also include volatile storage or memory 1222 and/or non-volatile storage or memory 1224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program components, scripts, source code, object code, byte code, compiled code, interpreted code, machine code, executable instructions, and/or the like to implement the functions of the user device 1010. As indicated, this may include a user application that is resident on the entity or accessible through a browser or other user interface for communicating with the management computing entity 1000 and/or various other computing entities.

In another embodiment, the user device 1010 may include one or more components or functionality that are the same or similar to those of the management computing entity 1000, as described in greater detail above. As will be recognized, these architectures and descriptions are provided for example purposes only and are not limiting to the various embodiments.

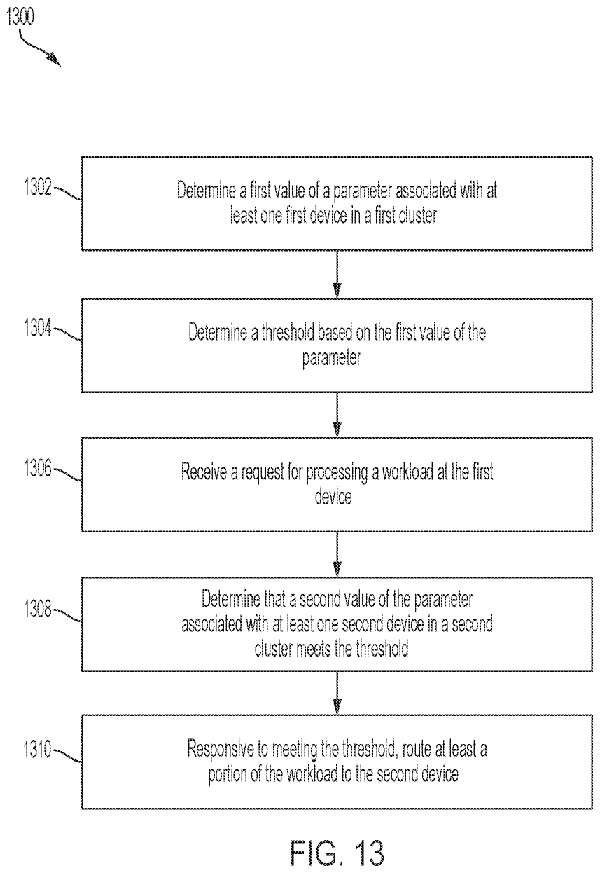

FIG. 13 is an illustration of an exemplary method 1300 of operating the disclosed systems to determine workload distributions across one or more clusters of a network, in accordance with example embodiments of the disclosure. At block 1302, the disclosed systems can determine a first value of a parameter associated with at least one first device in a first cluster. At block 1304, the disclosed systems can determine a threshold based on the first value of the parameter. At block 1306, the disclosed systems can receive a request for processing a workload at the first device. At block 1308, the disclosed systems can determine that a second value of the parameter associated with at least one second device in a second cluster meets the threshold. At block 1310, the disclosed systems can, responsive to meeting the threshold, route at least a portion of the workload to the second device.

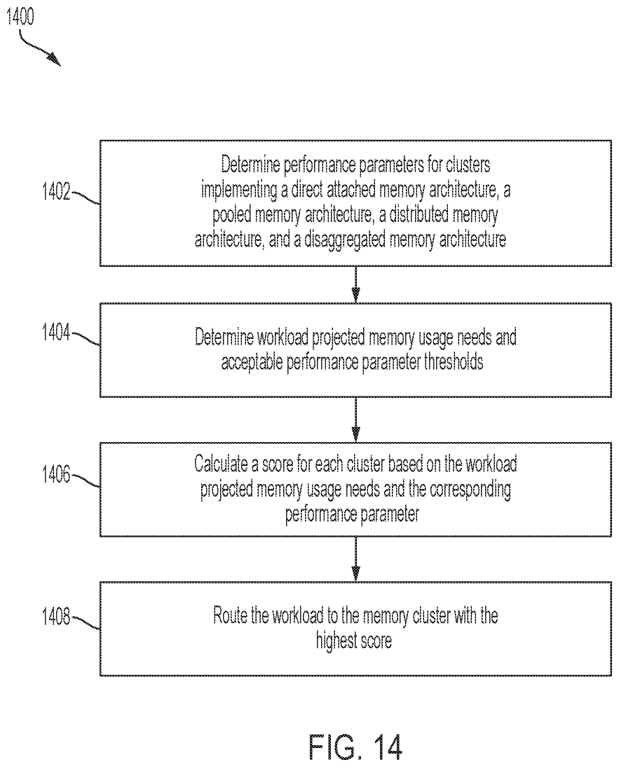

FIG. 14 is an illustration of another exemplary method 1400 of operating the disclosed systems to determine workload distributions across one or more clusters of a network, in accordance with example embodiments of the disclosure. At block 1402, the disclosed systems can determine performance parameters for clusters implementing a direct attached memory architecture, a pooled memory architecture, a distributed memory architecture, and a disaggregated memory architecture. At block 1404, the disclosed systems can determine workload projected memory usage needs and acceptable performance parameter thresholds. At block 1406, the disclosed systems can calculate a score for each cluster based on the workload projected memory usage needs and the corresponding performance parameter. At block 1408, the disclosed systems can route the workload to the memory cluster with the highest score.

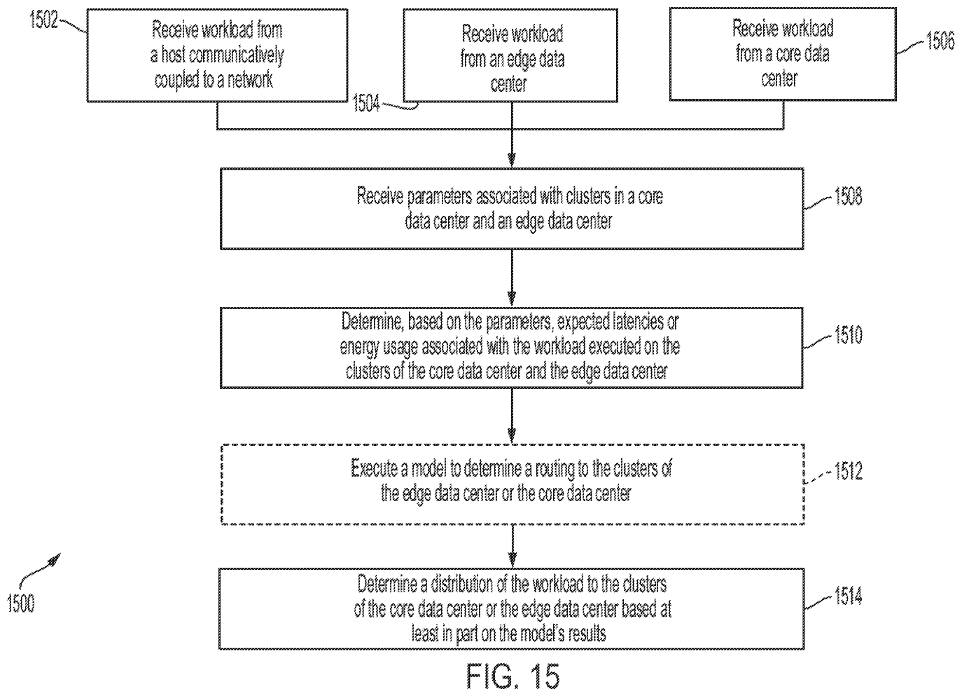

FIG. 15 is an illustration of an exemplary method 1500 of operating the disclosed systems to determine a distribution of a workload over a network architecture including clusters as described herein, in accordance with example embodiments of the disclosure. At block 1502, the disclosed systems can receive a workload from a host communicatively coupled to a network. In some embodiments, the host can include a host on the Internet. In some examples, the workload can originate from a device connected to the host, for example, a user device (e.g., a mobile phone) that requests a particular service (e.g., a video streaming request, a search request, combinations thereof, and/or the like). In some aspects, the reception of the workload from the host can be similar, but not necessarily identical to, the process shown and described in connection with FIG. 5, above.

At block 1504, the disclosed systems can receive workload from an edge data center. Similar to block 1502, the workload can originate from a device connected to the edge data center, for example, a user device (e.g., a mobile phone) that requests a particular service (e.g., a video streaming request, a search request, combinations thereof, and/or the like). In some aspects, the reception of the workload from the host can be similar, but not necessarily identical to, the process shown and described in connection with FIG. 7, above.

At block 1506, the disclosed systems can receive workload from a core data center. Similar to blocks 1502 and 1504, the workload can originate from a device connected to the edge data center or core data center, for example, a user device (e.g., a mobile phone) that requests a particular service (e.g., a video streaming request, a search request, etc.). In some aspects, the reception of the workload from the host can be similar, but not necessarily identical to, the process shown and described in connection with FIG. 6, above.

In some examples, the disclosed systems can receive a portion of the workloads from a combination of any of the host, edge data center, and/or core data center, for example, in a disaggregated manner. For example, more than one device requesting the service can be connected in a peer-to-peer (P2P) connection and can originate a composite workload that can be received at different portions of the network architecture (e.g., the host, edge data center, and/or core data center). Further, the disclosed systems can aggregate the partial workload requests at the management computing entity (which itself can be executed partially or in full at any suitable location on the network architecture) for further processing as per the operations described below.

At block 1508, the disclosed systems can receive parameters associated with clusters in a core data center and an edge data center. In particular, the disclosed systems can employ the management computing entity shown and described variously herein to monitor the network architecture to determine parameters. In some embodiments, the disclosed systems may intercept or otherwise access raw data that is transmitted on various portions of the network architecture and determine, from the raw data, certain parameters including, but not limited to, data rates, machine utilization ratios, memory capability, remote memory capacity, and/or the like, for example, as further shown and described in connection with FIG. 4, above.

At block 1510, the disclosed systems can determine, based on the parameters, expected latencies or energy usage associated with the workload executed on the clusters of the core data center and the edge data center. In particular, the disclosed systems can use a model as further shown and described in connection with FIGS. 8-9 to determine latencies associated with the workload. Non-limiting examples of the latencies can include the service time delay including the processing and communications delays. In some embodiments, the disclosed systems can determine the latencies that are mapped to a specific network architecture implementing specific protocols (e.g., 5G network protocols). Further, non-limiting examples of energy usage can include performance per watt or performance per unit currency (e.g., dollars) of executing a particular workload on a cluster of a given core or edge data center.

At block 1512, the disclosed systems can optionally execute a model to determine a routing to the clusters of the edge data center or the core data center. In particular, the disclosed systems can implement a machine learning technique to determine an optimal routing to the edge data center or the core data center. For example, the disclosed systems can implement a supervised machine learning technique as further shown and described in connection with FIG. 8 or an unsupervised machine learning technique, as further shown and described in connection with FIG. 9, to determine the expected distribution for routing a workload to clusters associated with the edge data center or the core data center. In other examples, the disclosed systems may implement predetermined rules (e.g., user-specified policies) for routing the workloads to clusters of the edge data center or the core data center as opposed to or in combination with the machine learning approach.

At block 1514, the disclosed systems can determine a distribution of the workload to clusters of the core data center or the edge data center based at least in part on the model's results. In particular, the disclosed systems can determine to transmit a first portion of the workload to a cluster of core data center and a second portion of the workload to a cluster of the edge data center as characterized by the determined distribution. In some embodiments, the disclosed systems can determine the distribution that is likely to affect a particular parameter (e.g., reduce the overall latency (e.g., the service delay)) of the network architecture. In other aspects, the disclosed systems can further determine a distribution to reduce other factors associated with network architecture including, but not limited to, the bandwidth usage of the network, the power usage of the network or portions of the network, combinations thereof, and/or the like.

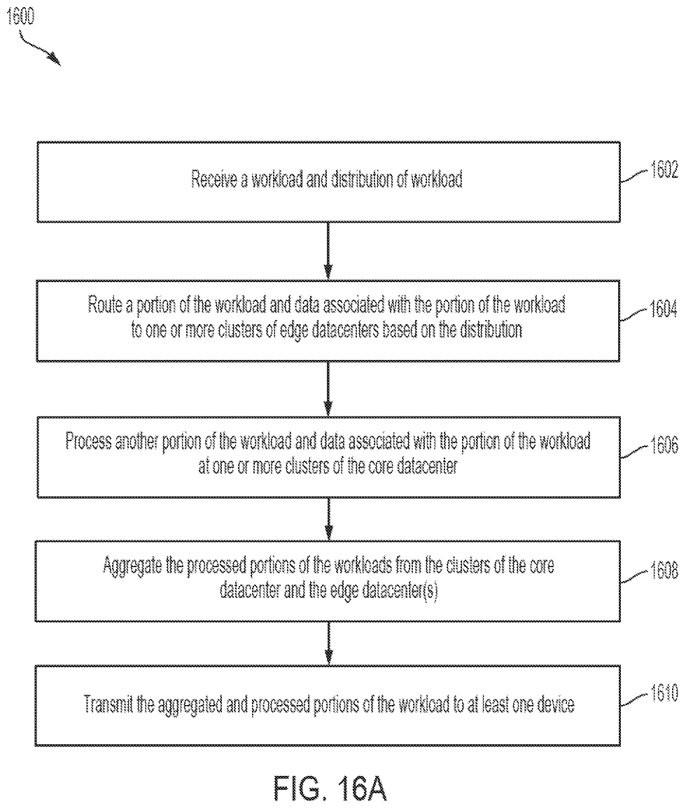

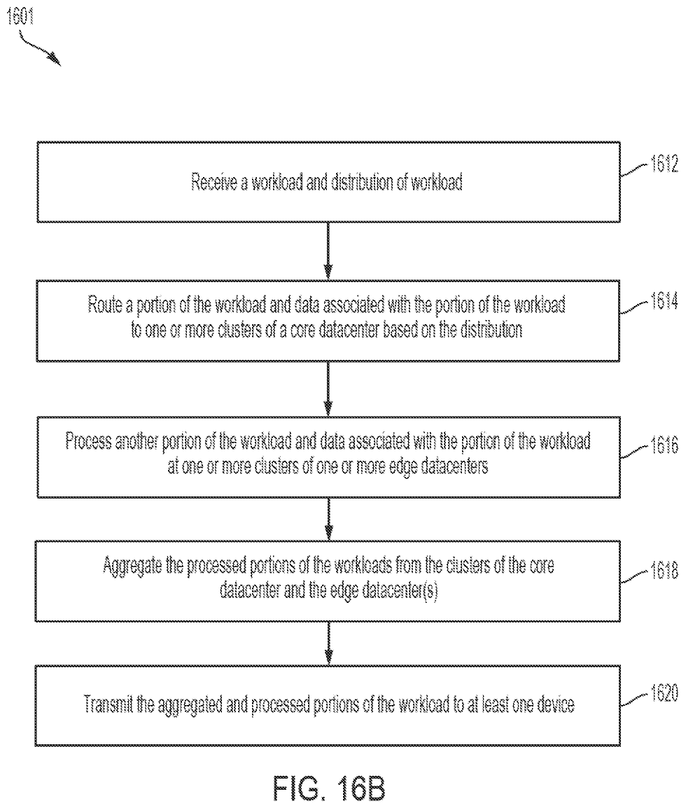

FIG. 16A is an illustration of an exemplary method 1600 of the disclosed systems to route the workload to clusters of a core data center and clusters of one or more edge data centers over a network architecture, in accordance with example embodiments of the disclosure. At block 1602, the disclosed systems can receive a workload and distribution of the workload. In some embodiments, a management computing entity residing on the core network can receive the workload and distribution. As noted above, the workload can originate from a device connected to a host on the Internet or the core data center, for example, a user device (e.g., a mobile phone) that requests a particular service (e.g., a video streaming request, a search request, combinations thereof, and/or the like). Further, the distribution of the workload can be determined from the results of the machine learning technique described above in connection with FIGS. 8 and 9 and described throughout the disclosure. In an example, the distribution can be determined based at least in part on the difference between a first programmatically expected latency associated with at least one device in a cluster associated with core data center and a second programmatically expected latency associated with a device associated with a device in an edge data center exceeding a predetermined threshold.

At block 1604, the disclosed systems can route a portion of the workload and data associated with the portion of the workload to one or more clusters of one or more edge data centers based on the distribution. In particular, the disclosed systems can break up discrete components of the workload into modular tasks, generate a series of packets associated with the discrete components of the workload, and transmit the packets over the network architecture to designated portions of the network (e.g., various clusters associated with one or more edge data centers), as appropriate. Further, the disclosed systems can encapsulate the discrete components with any appropriate headers for transmission over any underlying network medium. For example, the disclosed systems can encapsulate the discrete components of the workload with a first metadata associated with first network protocol (e.g., 5G protocol) and can encapsulate the discrete components of the workload with a second metadata associated with a second network protocol (e.g., Ethernet protocol) for transmission to a cluster associated with a first edge data center and another cluster associated with a second edge data center, respectively.

At block 1606, the disclosed systems can process another portion of the workload and data associated with the portion of the workload at one or more clusters of the core data center. In particular, the disclosed systems can retain a portion of the workload for processing at one or more clusters associated with the core data center. For example, the portions processed at the one or more clusters associated with the core data center may require a relatively higher level of computational resources, which may be available at the one or more clusters associated with core data center as opposed to one or more clusters associated with edge data center(s). In some embodiments, the disclosed systems can process the portion of the workload in accordance with any suitable service level agreement (SLA).

At block 1608, the disclosed systems can aggregate the processed portions of the workloads from the cluster(s) of the core data center and the edge data center(s). In some examples, the disclosed systems can include tags for the different portions of the workload, the tags reflecting the portion of the network (e.g., one or more clusters associated with the core or edge data center) that processed the respective portion of the workload. For example, the tags can be included in metadata associated with the portions of the workload (e.g., metadata associated with packets representing the portions of the workload). Accordingly, the disclosed systems can classify, filter, and/or aggregate the processed portions using the tags. In particular, the disclosed systems can receive a first completed workload associated with the first portion from a given cluster of the data center, and receive a second completed workload associated with the second portion from another cluster of the edge data center, and classify, filter, or aggregate the first completed workload or the second completed workload using the first tag or second tag.

At block 1610, the disclosed systems can transmit the aggregated and processed portions of the workload to at least one device. In some embodiments, the disclosed systems can transmit the aggregated and processed portions to a device that is located at a similar or different portion of the network than the device that originated the workload request.

FIG. 16B is an illustration of another exemplary method 1601 of the disclosed systems to route the workload to one or more clusters associated with a core data center and one or more clusters associated with one or more edge data centers over a network architecture, in accordance with example embodiments of the disclosure. At block 1612, the disclosed systems can receive a workload and distribution of the workload. In some embodiments, a management computing entity residing on the edge network can receive the workload and distribution. As noted above, the workload can originate from a device connected to a host on the Internet or the core data center, for example, a user device (e.g., a mobile phone) that requests a particular service (e.g., a video streaming request, a search request, etc.). Further, the distribution of the workload can be determined from the results of a machine learning technique described above and described throughout the disclosure.

At block 1614, the disclosed systems can route a portion of the workload and data associated with the portion of the workload to one or more clusters of a core data center based on the distribution. As noted, the disclosed systems can break up discrete components of the workload into modular tasks, generate a series of packets associated with the discrete components of the workload, and transmit the packets over the network architecture to designated portions (e.g., one or more clusters of core data centers), as appropriate. Further, the disclosed systems can encapsulate the discrete components with any appropriate headers for transmission over any underlying network medium. For example, the disclosed systems can encapsulate the discrete components of the workload with a first metadata associated with first network protocol (e.g., a 5G-based network protocol) and can encapsulate the discrete components of the workload with a second metadata associated with a second network protocol (e.g., an Ethernet-based network protocol) for transmission to one or more clusters of a first core data center and one or more clusters of a second core data center, respectively.

At block 1616, the disclosed systems can process another portion of the workload and data associated with the portion of the workload at one or more clusters of one or more edge data centers. In particular, the disclosed systems can retain a portion of the workload for processing at one or more clusters of the edge data center(s). For example, the portions processed at the one or more clusters of edge data center(s) may require a relatively lower level of computational resources but reduced latencies, which may be available at one or more clusters of an edge data center as opposed to the one or more clusters of the core data center. In some embodiments, the disclosed systems can process the portion of the workload in accordance with any suitable SLA.

At block 1618, the disclosed systems can aggregate the processed portions of the workloads from the one or more clusters of the core data center and the edge data center(s). In some examples, as noted, the disclosed systems can include tags for the different portions of the workload, the tags reflecting the portion of the network (e.g., one or more clusters of the core or edge data center) that processed the respective portion of the workload. For example, the tags can be included in metadata associated with the portions of the workload (e.g., metadata associated with packets representing the portions of the workload). Accordingly, the disclosed systems can classify, filter, and/or aggregate the processed portions using the tags.

At block 1620, the disclosed systems can transmit the aggregated and processed portions of the workload to at least one device. In some embodiments, the disclosed systems can transmit the aggregated and processed portions to a device that is located at a similar or different portion of the network than the device that originated the workload request.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for resource allocation, comprising:
determining a first value of a parameter associated with at least one first device in a first cluster;
determining a threshold based on the first value of the parameter;
receiving a request for processing a workload at the first device;
determining that a second value of the parameter associated with at least one second device in a second cluster meets the threshold; and
responsive to meeting the threshold, routing at least a portion of the workload to the second device.

2. The method of claim 1, wherein the method further comprises:
determining that the second value of the parameter associated with at least one second device in a second cluster exceeds the threshold; and
responsive to exceeding the threshold, maintaining at least a portion of the workload at the first device.

3. The method of claim 1, wherein the first cluster or second cluster comprises at least one of a direct-attached memory architecture, a pooled memory architecture, a distributed memory architecture, or a disaggregated memory architecture.

4. The method of claim 3, wherein the direct-attach memory architecture comprises at least one of a storage class memory (SCM) device, a dynamic random-access memory (DRAM) device, and a DRAM-based vertical NAND device.

5. The method of claim 3, wherein the pooled memory architecture comprises a cache coherent accelerator device.

6. The method of claim 3, wherein the distributed memory architecture comprises cache coherent devices connected with PCIe interconnects.

7. The method of claim 3, wherein the disaggregated memory architecture comprises a physically clustered memory and accelerator extension in a chassis.

8. The method of claim 1, wherein the method further comprises:
calculating a score based on a projected memory usage of the workload, the first value, and the second value; and
routing at least a portion of the workload to the second device based on the score.

9. The method of claim 1, wherein the routing at least a portion of the workload to the second device comprises routing using a cache coherent protocol, the cache coherent protocol further comprising at least one of a CXL protocol or a GenZ protocol, and the first cluster and the second cluster are coupled via a PCIe fabric.

10. The method of claim 1, wherein the parameter is associated with at least one of a memory resource or a computing resource.

11. The method of claim 1, wherein the parameter comprises at least one of a power characteristic, a performance per unit of energy characteristic, a remote memory capacity, and a direct memory capacity.

12. A device for resource allocation, comprising:
at least one memory device that stores computer-executable instructions; and
at least one processor configured to access the memory device, wherein the processor is configured to execute the computer-executable instructions to:
determine a first value of a parameter associated with at least one first device in a first cluster;
determine a threshold based on the first value of the parameter;
receive a request for processing a workload at the first device;
determine that a second value of the parameter associated with at least one second device in a second cluster meets the threshold; and
responsive to meeting the threshold, route at least a portion of the workload to the second device.

13. The device of claim 12, wherein the processor is further configured to execute the computer-executable instructions to:
determine that the second value of the parameter associated with at least one second device in a second cluster exceeds the threshold; and
responsive to exceeding the threshold, maintain at least a portion of the workload at the first device.

14. The device of claim 12, wherein the first cluster or second cluster comprises at least one of a direct-attached memory architecture, a pooled memory architecture, a distributed memory architecture, or a disaggregated memory architecture.

15. The device of claim 14, wherein the direct-attach memory architecture comprises at least one of a storage class memory (SCM) device, a dynamic random-access memory (DRAM) device, and a DRAM-based vertical NAND device.

16. The device of claim 12, wherein the device is further configured to present at least the second device to a host.

17. A system for resource allocation, comprising:
at least one memory device that stores computer-executable instructions; and
at least one processor configured to access the memory device, wherein the processor is configured to execute the computer-executable instructions to:
determining a first value of a parameter associated with at least one first device in a first cluster;
determining a threshold based on the first value of the parameter;
receiving a request for processing a workload at the first device;
determining that a second value of the parameter associated with at least one second device in a second cluster meets the threshold; and
responsive to meeting the threshold, routing at least a portion of the workload to the second device.

18. The system of claim 17, wherein the processor is further configured to execute the computer-executable instructions to:
determine that the second value of the parameter associated with at least one second device in a second cluster exceeds the threshold; and
responsive to exceeding the threshold, maintaining at least a portion of the workload at the first device.

19. The system of claim 17, wherein the first cluster or second cluster comprises at least one of a direct-attached memory architecture, a pooled memory architecture, a distributed memory architecture, or a disaggregated memory architecture.

20. The system of claim 19, wherein the direct-attach memory architecture comprises at least one of a storage class memory (SCM) device, a dynamic random-access memory (DRAM) device, and a DRAM-based vertical NAND device.
